(19) United States
(12) Patent Application Publication
(10) Pub. No.: US 2024/0179577 A1
(43) Pub. Date: May 30, 2024

(54) Systems and Methods for Monitoring and Detection of Anomalous Activity in Software-Defined Radio Access Networks

(71) Applicants: SRI International, Menlo Park, CA (US); Ohio State Innovation Foundation, Columbus, OH (US)

(72) Inventors: Phillip Andrew Porras, Cupertino, CA (US); Vinod Trivandrum Yegneswaran, Menlo Park, CA (US); Haohuang Wen, Menlo Park, CA (US)

(21) Appl. No.: 18/516,449

(22) Filed: Nov. 21, 2023

Related U.S. Application Data
(60) Provisional application No. 63/385,238, filed on Nov. 29, 2022.

(51) Int. Cl. H04W 28/24; H04W 12/08; H04W 12/122; H04W 28/08

(52) U.S. Cl. CPC H04W 28/24; H04W 12/08; H04W 12/122; H04W 28/0975; H04B 1/0003

(57) ABSTRACT

An example method for monitoring a software-defined radio access network (SD-RAN) includes receiving, by a computing device, data indicative of communications between a base station configured to provide radio access and one or more network devices. The method also includes generating, by the computing device and based on the data, a telemetry stream indicative of potential anomalous activity in the SD-RAN. The method further includes providing, by the computing device and based on the telemetry stream, an indication of the potential anomalous activity.

### CROSS-REFERENCE TO RELATED APPLICATIONS

This application claims priority to U.S. Provisional Patent Application No. 63/385,238, titled “A 5G Data-Plane Security Module for Software-Defined Radio Access Networks,” filed on Nov. 29, 2022, which is hereby incorporated by reference in its entirety.

### BACKGROUND

Higher generation cellular networks (e.g., fifth-generation (5G) or higher generation networks) have significantly impacted many sectors, including communication, transportation, entertainment, manufacturing, and healthcare. Some characteristics of such higher generation cellular networks involve their low latency and high data bandwidth. Software-defined networks provide an open platform and interoperability, and enable programmability that allows stakeholders (e.g., network operators) and researchers to configure software-defined services for the network.

### SUMMARY

Software-defined networks enable services that may be configured to secure a network. Due to the availability of inexpensive commercial-off-the-shelf (COTS) software-defined radios (SDRs) and open-source cellular software stacks, there is a relatively low economic and technical barrier for adversarial attacks in such networks. Attacks may include, for example, employing a malicious network device, fake base stations, and/or Man-in-the-Middle (MiTM) attacks. Such threats can trigger service outages, privacy leakage, and quality-level downgrades, thereby compromising the security, privacy, and availability of the network for end-users.

Detecting and/or defending against such attacks can be a challenging task as the attacks may operate on cellular control messages, such as, for example, the layer-3 (L3) protocols such as session establishment protocols (e.g., Radio Resource Control (RRC)) and device authentication in mobile protocols (e.g., Non-Access Stratum (NAS)). Such attacks generally leverage the vulnerabilities in earlier generations of cellular protocols and continue to be applicable to higher generation cellular networks. Some existing approaches address a subset of these attacks from either the network device side or the network side. However, such approaches are generally based on a limited view (e.g., network device-centric defenses cannot detect radio access network (RAN)-targeted attacks) or poor extensibility (e.g., network-based solutions with static defense mechanisms).

Software-defined networks are generally configured to disaggregate the control and data management functions of the cellular network into layers, such as (a) a network layer that provides the base-station functions of radio frequency (RF) transmission, link establishment and authentication, and data flow management, and (b) a control layer segregated to a centrally governed cloud ecosystem that provides a vendor neutral framework for integrating control and management functions for one or more base stations. Software-defined networks may be configured to support cell stations and/or base stations that can be modularly decomposed into a Radio Unit (RU), Data Unit (DU), and Control Unit (CU). As described herein, the design features of software-defined networks facilitate a modular extension of the data plane's CU and DU with a security service component that may be configured to perform a fine-grained audit of the network communications between the CUS, DUs, and base stations, as well has operational aspects of the network devices. Also, for example, software-defined networks may be include standard application programming interfaces (APIs).

For example, the security service may be configured to collect data from the network layer, generate a telemetry stream, and enable a modular extension of the control layer functions with new xApps capable of monitoring the cellular network, detecting anomalous activity, and/or mitigating such anomalous activity. This may include a wide range of attacks that directly target communications between network devices and base stations. This can enhance the reliability and resilience of higher generation cellular networks against a wide range of attacks and anomalous activity. Also, for example, runtime detection of malicious network devices (e.g., network devices that attempt to interfere in the operations of the base station), and attacks from external transmitters (e.g., transmitters that attempt to disrupt or hijack communications between the base station and the network devices) may be achieved.

For example, a software-defined radio access network (SD-RAN) from the Open Networking Foundation (ONF) implements a cloud-native RAN intelligent controller (RIC), an xApp development environment and a set of xApps for controlling open RAN elements such as logical nodes (e.g., RU, DU, and CU). In some embodiments, the RIC may be a near real-time RIC (nRT-RIC). As described herein, a data-plane security service for software-defined networks may be configured to enable control plane (e.g., xApp) security services to counter a wide range of adversarial models against the cellular networks. For example, an E2 service module (E2SM), referred to herein as a security service module (SecSM), may be introduced into the SD-RAN reference implementation for the ONF. SecSM may be configured to generate an E2T event stream, referred to herein as a telemetry stream or MobiFlow. MobiFlow may be configured to capture connection state attributes between a network device and a base station (e.g., eNodeB), and eNB statistics, to drive advanced security focused xApps.

A reference SecSM and a runtime MobiFlow 5G intrusion detection system (IDS) capable of thwarting a wide range of attacks against network device and eNB operations for higher generation software-defined networks is described herein. The IDS described herein, referred to as SPECTOR, may be configured to monitor and/or detect several different types of anomalous activities, including, but not limited to, an attack on a base station or a user equipment, a fault in a network device, a failure of network device, a security threat, a noncompliance by a network device, or a violation of a service level agreement (SLA).

In a first aspect, a method for monitoring a software-defined radio access network (SD-RAN) is provided. The method includes receiving, by a computing device, data indicative of communications between a base station configured to provide radio access and one or more network devices. The method also includes generating, by the computing device and based on the data, a telemetry stream indicative of potential anomalous activity in the SD-RAN. The method further includes providing, by the computing device and based on the telemetry stream, an indication of the potential anomalous activity.

In a second aspect, a computing device for monitoring a software-defined radio access network (SD-RAN) is provided. The computing device includes one or more processors, and data storage. The data storage has stored thereon computer-executable instructions that, when executed by the one or more processors, cause the computing device to carry out operations. The operations include receiving, by the computing device, data indicative of communications between a base station configured to provide radio access and one or more network devices. The operations also include generating, by the computing device and based on the data, a telemetry stream indicative of potential anomalous activity in the SD-RAN. The operations further include providing, by the computing device and based on the telemetry stream, an indication of the potential anomalous activity.

In a third aspect, a system for monitoring a software-defined radio access network (SD-RAN) is provided. The system includes one or more network devices. The system also includes a base station configured to provide radio access to the one or more network devices. The system further includes one or more processors, and data storage. The data storage has stored thereon computer-executable instructions that, when executed by the one or more processors, cause the computing device to carry out operations. The operations include receiving, by the computing device, data indicative of communications between the base station and the one or more network devices. The operations also include generating, by the computing device and based on the data, a telemetry stream indicative of potential anomalous activity in the SD-RAN. The operations further include providing, by the computing device and based on the telemetry stream, an indication of the potential anomalous activity.

### BRIEF DESCRIPTION OF THE FIGURES

FIG. 1 illustrates example cellular network procedures, in accordance with example embodiments.

FIG. 2 illustrates an example architecture for a software-defined radio access network (SD-RAN), in accordance with example embodiments.

FIG. 3 depicts an overview of an example architecture to generate a telemetry stream for monitoring a software-defined radio access network (SD-RAN), in accordance with example embodiments.

FIG. 3 shows a block diagram depicting an example implementation of an E2 service module (E2SM) in a protocol stack, in accordance with example embodiments.

FIG. 4 depicts a detailed view of an example architecture to generate a telemetry stream for monitoring a software-defined radio access network (SD-RAN), in accordance with example embodiments.

FIG. 5 illustrates an example workflow for a setup procedure and a subscription procedure, in accordance with example embodiments.

FIG. 6 illustrates a table summarizing example data, in accordance with example embodiments.

FIG. 7 displays an example algorithm for data collection, in accordance with example embodiments.

FIG. 8 illustrates a table with example data utilized by MobiFlow stream records, in accordance with example embodiments.

FIG. 9A illustrates an example finite-state machine for a user equipment, in accordance with example embodiments.

FIG. 9B illustrates a table with example aggregated data for a user equipment (UE), in accordance with example embodiments.

FIG. 9C illustrates a table with example aggregated data for a radio access network (RAN), in accordance with example embodiments.

FIG. 10 illustrates an example abstract syntax tree for P-BEST language, in accordance with example embodiments.

FIG. 11 illustrates a table with results of an implementation of an intrusion detection system based on example attacks, in accordance with example embodiments.

FIG. 12 illustrates a table with results of an evaluation of known and unknown attacks, in accordance with example embodiments.

FIG. 13 illustrates a table with results of an evaluation using real-world cellular traffic, in accordance with example embodiments.

FIG. 14 illustrates an example over-the-air (OTA) attack setup, in accordance with example embodiments.

FIG. 15 displays graphical illustrations of performance evaluations, in accordance with example embodiments.

FIG. 16 displays graphical illustrations of overhead evaluations, in accordance with example embodiments.

FIG. 17 depicts a network environment, in accordance with example embodiments.

FIG. 18 depicts a protocol stack, in accordance with example embodiments.

FIG. 19 is a block diagram of an example computing device, in accordance with example embodiments.

FIG. 20 illustrates an example method, in accordance with example embodiments.

### DETAILED DESCRIPTION

The design of some software-defined networks separates the control plane (also referred to herein as a control layer) that manages network topology, from the data plane (also referred to herein as a network layer) that performs packet processing and forwarding. Such software-defined networks have programmable components. For example, the control plane logic may be integrated into a RAN Intelligent Controller (RIC), which can serve as a standalone programmable component to manage the RAN nodes. Also, for example, custom application-layer services, such as performance measurement and traffic steering applications, may be developed as “plug-n-play” xApps on the RIC. They may be associated with E2 service models (E2SMs) that provide support for communications with RAN nodes. Based on such an example design, sophisticated analytics may be integrated as xApps into the RIC for a variety of network monitoring and control functions. Although some of the description herein may be provided in the context of an open radio access network (O-RAN), this is for illustrative purposes only. The techniques described herein may be applicable to a higher generation software-defined network, and a 5G O-RAN is to be considered as a particular example.

For example, an O-RAN-resident framework to detect L3 cellular attacks is described. The framework enables network experts to program detection logic integrated into an xApp. The xApp may be configured to function as an IDS. The framework may be configured to operate on data with high granularity to support fine-grained monitoring, analysis, and/or detection of potentially anomalous activities. The framework may also be configured to have the extensibility that enables new detection mechanisms to be integrated for both contemporary and emergent network exploits. Also, for example, the framework may be configured to support the processing of a large volume of packets and report of malicious exploit events in near real-time.

For example, the framework may include plugins and xApps that augment the data plane and the control plane. An audit stream, such as MobiFlow, may be configured for fine-grained monitoring, analysis, and/or detection of potentially anomalous activities. MobiFlow may be generated by a network compliant secure service module (SecSM). Network packets may be aggregated into flow records during network transmission. Subsequently, the flow records may be converted into packet-level telemetry streams. An xApp, such as MobiExpert, may be configured based on a programming language (e.g., a Production-Based Expert System Toolset (P-BEST) language). For example, MobiExpert may be configured with programmability that enables network operators to tailor production rules to monitor, analyze, and/or detect anomalous network activity comprehensively, and with a high degree of precision.

### Example Cellular Network Procedures

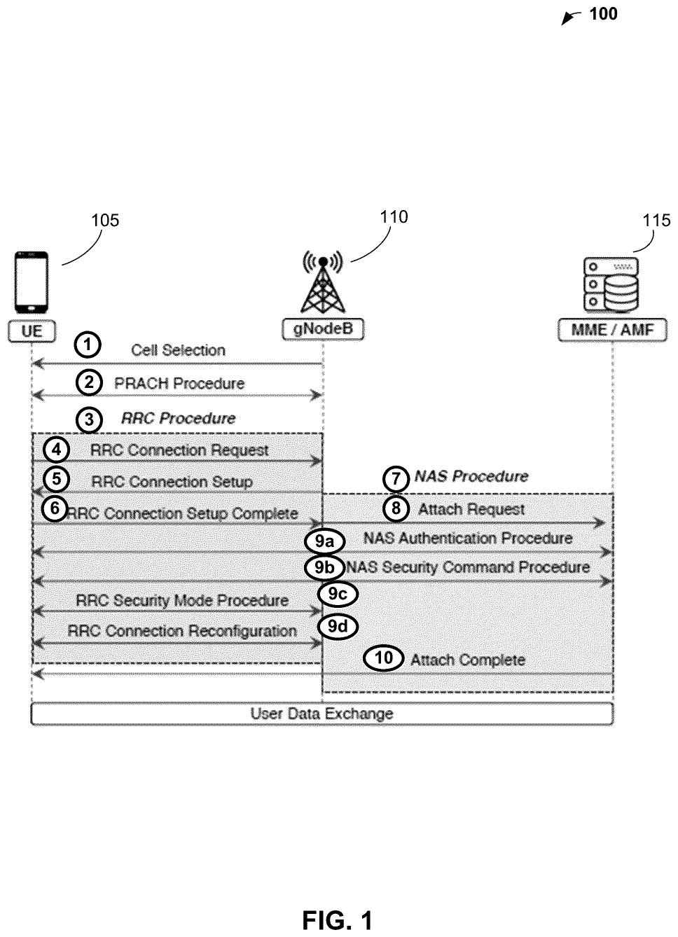

FIG. 1 illustrates example cellular network procedures 100, in accordance with example embodiments. Cellular networks generally include entities such as network devices (e.g., user equipment (UE) 105)) that may subscribe to an operational network through a Universal Subscriber Identity Module (USIM), a gNodeB 110, or base station (BS), located within the RAN, which connects UE 105 to the operator's network, and a core network (CN) handling services such as authentication and key agreement. The term “network device” as used herein may include any device that may be configured to connect to and/or operate within a network. For example, a network device can include an unmanned autonomous vehicle (UAW), a semi-autonomous or autonomous vehicle, an internet-of-things (IoT) device, a smartphone, a wearable device, a camera, or any other mobile device, or wired device. Also, for purposes of illustration, a network device is also referred to herein as a user equipment UE). However, in general, network devices are to be understood to include user equipments.

Generally, gNodeB 110 may connect to an LTE Evolved Packet Core (EPC), a 5G Core (5GC), and so forth, shown as Mobility Management Entity/Access and Mobility Management Function (MME/AMF) 115, and referred to as a non-standalone (NSA) mode or a standalone (SA) mode, respectively. For example, prior to establishing a data connection, UE 105 may connect to a nearby gNodeB 110 and register with the EPC or 5GC through various procedures in the cellular control plane. These procedures are now described in greater detail to provide context to the design and implementation of the systems and methods described herein.

### Cell Selection and PRACH Procedure

At step 1, call selection may involve selection of a gNodeB for UE 105 to connect to. To this end, UE 105 acquires and decodes one or more System Information Block (SIB) messages broadcast from each nearby gNodeB (e.g., gNodeB 110). Based on the gNodeB meta information and status in the SIB messages, UE 105 perform internal measurements to select an optimal gNodeB, such as, for example, gNodeB 110.

At step 2, PRACH procedure may involve initialization of a physical random access channel (PRACH) by UE 105 and the selected gNodeB (e.g., gNodeB 110). During PRACH procedure, UE 105 may request uplink synchronization and may be allocated a Radio Network Temporary Identifier (RNTI) for radio access communication.

### Session Establishment Procedure

At step 3, the session establishment (e.g., Radio Resource Control (RRC)) procedure may be performed after the initial cell selection at step 1, and the PRACH procedure at step 2, have been completed.

Session establishment procedure may generally begin at step 4 with an RRC Connection Request message initiated by UE 105. The RRC Connection Request message may include an establishment cause and identifier (e.g., a random identity or its Temporary Mobile Subscriber Identity (TMSI) if the UE has been allocated one previously) associated with UE 105.

In the event that gNodeB 110 agrees to set up the connection, gNodeB 110 may send, at step 5, a downlink RRC Connection Setup message with the configuration information for UE 105.

Subsequently, at step 6, UE 105 may complete the handshake with a Connection Setup Complete message.

### Device Authentication Procedure

At step 7, the device authentication (e.g., Non-Access Stratum (NAS)) procedure may be performed after a session is established (e.g., an RRC connection is established) when UE 105 attempts to attach to the EPC/5GC. More precisely, the NAS messages may be transmitted between UE 105 and the MME/AMF 115. Generally, AMF is performed in a 5GC, and MME is performed in an EPC. The NAS messages may be relayed by gNodeB 110.

As illustrated in FIG. 1, a typical NAS procedure may begin at step 8, with an Attach Request if this is an initial attachment. The Attach Request includes temporary (TMSI) or permanent identifiers (e.g., such as its Subscription Concealed Identifier (SUCI) and International Mobile Subscriber Identity (IMSI)) associated with UE 105.

Next, at steps 9a-d (shown in multiple sub-steps), both parties may engage in authentication and security mode procedures to activate the encryption and integrity protection for future communications. This may involve an NAS Authentication Procedure at step 9a, an NAS Security Command Procedure at step 9b, an RRC Security Mode Procedure at step 9c, and/or an RRC Connection Reconfiguration at step 9d.

At step 10, the NAS procedure may culminate with a downlink Attach Complete message, and UE 105 may initiate user data transmission on the cellular data plane. Although not illustrated in FIG. 1, gNodeB 110 or the EPC/5GC 115 may reject the RRC or NAS connection and generate failure messages. For example, an NAS attach failure message may be transmitted if the request from UE 105 involves invalid values.

### Example SD-RAN

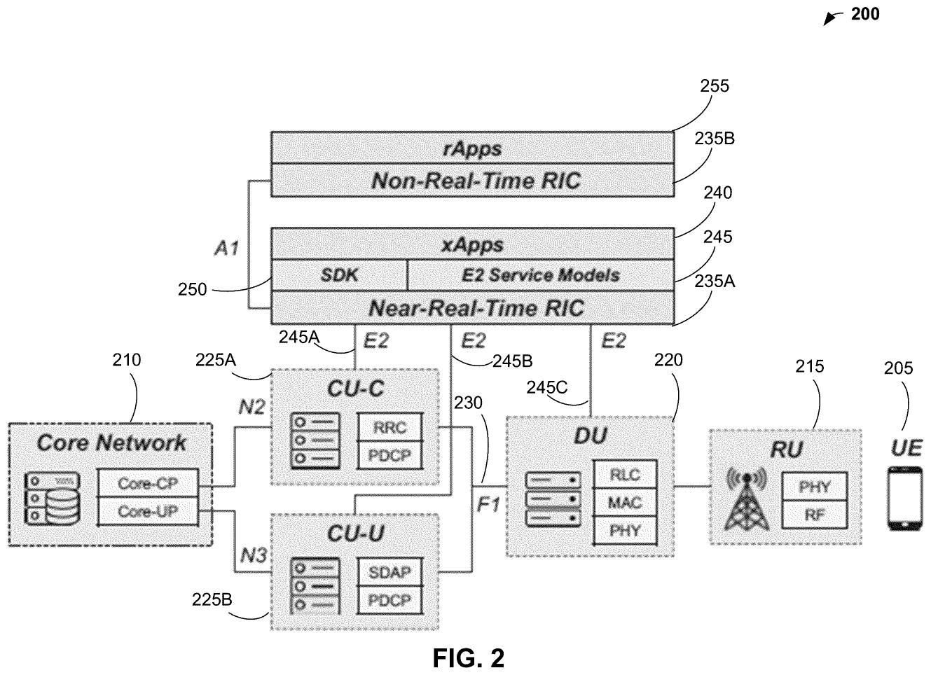

FIG. 2 illustrates an example architecture 200 for a software-defined radio access network (SD-RAN), in accordance with example embodiments. An O-RAN architecture is shown for illustrative purposes.

### Data Plane

The software-defined network environment may include a network device such as UE 205 (similar to UE 105 of FIG. 1) and core network 210 (similar to MME/AMF 115 of FIG. 1). The network architecture may incorporate one or more logical nodes including Radio Unit (RU) 215 (similar to gNodeB 110 of FIG. 1), Distributed Unit (DU) 220, and Central Unit (CU) comprising CU-control (CU-C) 225A and CU-user (CU-U) 225B. The RUs 215 are typical radio hardware deployed in the front-haul network to handle layer-1 (L1) physical radio signals from surrounding user equipment, such as UE 205. The DUs 220 and CUs (e.g., CU-C 225A and CU-U 225B) are logical components that can be hosted at the edge to handle L2 and L3 functions of the cellular protocol. The DU 220 handles L2 functions such as Media Access Control (MAC) and Radio Link Control (RLC). The CU (e.g., CU-C 225A and CU-U 225B) is responsible for L3 control functions such as RRC. For example, CU-C 225A forwards control-plane and CU-U 225B forwards user-plane traffic. Generally, CU-C 225A manages session establishment protocols, and state protocol transitions. Data from the CU-U 225B indicates communications between a user device and other network devices, a state and/or an activity of the central processing unit (CPU) for the device, and so forth. Such data is generally not available from CU-C 225A. The CU-C 225A and CU-U 225B are further attached to core network (CN) 210 functionality, such as the AMF and the User Plane Function (UPF). As an example, O-RAN data plane components may be connected via standard and open interfaces. For instance, DUs 220 and CUs (e.g., CU-C 225A and CU-U 225B) may be connected by the F1 interfaces 230. Also, for example, the N2/N3 interfaces may connect CU-C 225A and CU-U 225B to the core network 210.

As described herein, data from one or both of CU-C 225A and CU-U 225B may be used for effective monitoring of network devices. For example, CU-U 225B may indicate relevant security events for user devices. The combined data from CU-C 225A and CU-U 225B may be used to analyze attacks directed at an SLA. For example, data from CU-C 225A may indicate that a device is performing a series of state transitions, and that the device may be causing a denial-of-service (DoS) attack or a distributed DoS (DDoS) attack against the base station. As these activities may not impact the SLA, such data from CU-C 225A may be ignored for purposes of analyzing a potential anomalous activity involving the SLA. However, data from CU-U 225B regarding the CPU performance and user plane traffic from other devices that are connected to the base station may indicate an impact on the network devices. For example, the data from CU-U 225B may indicate that the base station is no longer able to serve or implement the SLA for several of the network devices. For example, a performance latency of a given network device may be compared to an expected performance for the given network device when interacting with the base station to determine performance anomalies. Thus, data from the CU-C 225A indicating that a device is performing a series of state transitions, and that the device may be causing a DDoS attack or a DoS attack against the base station, when combined with CPU performance data from CU-U 225B may indicate a violation of the SLA. Accordingly, collection, analysis, and/or correlation of data from CU-C 225A and CU-U 225B provides a significant improvement over existing intrusion detection systems.

Also, for example, data from DU 220 provides metadata indicative of a particular slice a network device may be in communication with. Such data is not available from CU-C 225A or CU-U 225B. Accordingly, attributes from DU 220 may be extracted in order to understand which devices may be associated with which network slices.

### Control Plane

The control layer logic may be disaggregated from the data plane based on software-defined network principles. For example, the O-RAN control functions may be realized in the RAN Intelligent Controller (RIC). Based on a latency constraint, RIC may be classified into the near-real-time RIC (nRT-RIC) 235A and non-real-time RIC 235B. Additional and/or alternative types of RIC are possible. For example, Flexible RIC (FlexRIC) is an open source O-RAN nRT-RIC that is implemented in the OpenAirInterface (OAI) radio software suite. FlexRIC may be configured to interface with the OAI radio stack over the O-RAN-defined E2-interface to monitor and control the RAN in real-time.

The control layer logic may be customized with hosted xApps 240. Generally speaking, RIC serves as a proxy for control services and connects to the RAN nodes (e.g., CU-Cs 225A, CU-Us 225B, and DUs 220) via respective E2 interfaces 245A, 245B, and 245C. The interactions between RIC 235 and the RAN nodes (e.g., CU-Cs 225A, CU-Us 225B, and DUs 220) may be defined by E2 operations such as Report, Insert, Control, and Policy. Based on these operations, xApps 240 may be programmed as “plug-n-play” software on RIC 235. An xApp 240 may be configured to define E2 Service Models (E2SMs) 245 as function-specific protocols on top of an E2 Application Protocol (E2AP) to engage with the data plane. Also, for example, xApp 240 leverages the software-development kit (SDK) 250. In some embodiments, a control loop of an nRT-RIC 235A may complete in approximately 10 milliseconds (ms) to 1000 ms, while non-real-time tasks (e.g., machine learning model training) may be hosted as rApps 255 on the non-real-time RIC 235B with approximately over 1 second (s) latency.

As illustrated, xApps 240 may be based on an underlying E2 service model (E2SM) 245, and this can be leveraged to perform intrusion detection. Generally, existing threat detection models are based on reported data that may be coarse-grained for security analysis (e.g., a packet delay and a drop rate). On the other hand, although a packet-level telemetry that offers a high granularity may be configured, this can be computationally resource intensive due to the large cellular traffic volume. Accordingly, the architecture described herein strikes an appropriate balance between optimizing threat detection and selecting an appropriate granularity level for the reported data.

As threats in the cellular networks are likely to continue to evolve, the architecture described herein is extensible for current and future attacks, as well as current and future generations of cellular networks. Some existing approaches involve learning-based frameworks (e.g., automata-based and machine learning based approaches). However such approaches are not effective due to a lack of availability of sufficient adversary training samples in the public domain. Also, cellular IDS frameworks are generally static with relatively low flexibility. Accordingly, the architecture described herein is a flexible, rule-based expert system that enables users (e.g., network operators) to integrate rules in a programmatic manner. This may be based on a decoupled architecture (i.e., disaggregation of detection mechanisms from the system) and a low redeployment cost.

Another advantage of the architecture described herein is a high degree of efficiency. This facilitates detection and/or reporting of attacks in near real-time, and may be deployed in operational cellular networks, which often need to process a large number of cellular messages simultaneously. Accordingly, the architecture described herein relies on a rule inference engine that may be configured using an efficient programming language that facilitates processing of a large volume of data packets and generation of alerts and events with low latency.

### Example Architecture to Generate a Telemetry Stream

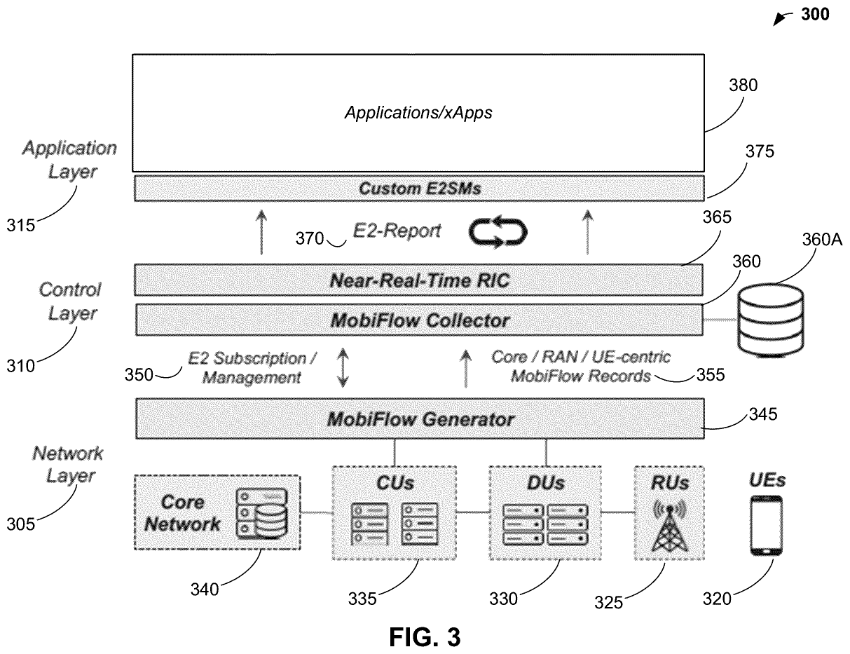

FIG. 3 depicts an overview of an example architecture 300 to generate a telemetry stream for monitoring a software-defined radio access network (SD-RAN), in accordance with example embodiments. As illustrated, in some embodiments, the architecture of MobiFlow may be deployed atop SD-RAN, and may be abstracted as three different layers: network layer 305, control layer 310, and application layer 315, which are further explained below. The telemetry stream may be configured to use an E2 protocol and a security component. Generally speaking, the telemetry stream may be configured to monitor security relevant protocols of the software-defined network, report significant state transitions, and/or extract security relevant statistics of CUs and DUs.

### Network Layer

As illustrated, network layer 305 may include components such as one or more network devices (e.g., user equipments (UEs) 320), one or more RUs 325, one or more DUs 330, one or more CUs 335, and a core network 340. The components of network layer 305 may follow various protocols of the SD-RAN. The network layer 305 collects data from the network components and exports MobiFlow records to the control layer 310. The term “data” as used herein may generally refer to security relevant base station statistics, and/or security relevant state transitions involving network protocols (e.g., layer 3 protocols). For example, network layer 305 may receive data comprising one or more network packets associated with the software-defined network, wherein the one or more network packets include communications data between devices such as core network 340, the one or more RUs 325, and the one or more UEs 320.

### Control Layer

Control layer 310 may serve as an intermediate component to provide basic services for the xApps, while maintaining consistency with the underlying architecture and protocols of the software-defined network. The control layer 310 may include functionality for collection and storage of flow records (e.g., by MobiFlow collector 360), E2 subscription/management 350 of the subscribed RAN nodes (e.g., DUs 330, CUs 335) via an E2 interface, and distribution of the MobiFlow records 355 to the xApps 380 (e.g., using E2-reports 370). In some embodiments, the flow records and/or other data may be stored in database 360A. The control layer 310 may serve as a proxy to manage subscriptions and transmission between the xApps 380 in application layer 315 and the one or more logical nodes in network layer 305.

In some embodiments, control layer 310 may include a MobiFlow generator 345 that is configured to generate, based on the one or more network packets received by network layer 305, a telemetry stream indicative of potential anomalous activity in the software-defined network. For example, MobiFlow generator 345 may generate a telemetry stream as MobiFlow by using security service module (e.g., SecSM) that complies with the underlying protocols of the software-defined network. For example, the fine-grained telemetry stream may be based on the one or more network packets from one or more logical nodes (e.g., DUs 330, CUs 335). Also, the xApps may be subscribed to E2SM via E2 subscription/management 350.

In some embodiments, MobiFlow generator 345 may aggregate network device-centric or RAN-centric data into flow records 355 and report them to MobiFlow collector 360 per trigger event. For example, network device-centric data may be converted into network device-centric flow records 355. The network device-centric data may include fine-grained statistics of a given network device, among UEs 320, that is subscribed to the cellular network. The network device-centric data may include meta information (e.g., identifiers and its subscribed network), states (e.g., RRC connection states and security conditions), control-plane traffic (e.g., RRC message sequences), user-plane traffic, security algorithms, error codes, timers, and/or additional aggregated statistics (e.g., counters for connection failure and establishment). The network device-centric MobiFlow enables the security xApps 380 on the nRT-RIC 365 to assess the security of UEs 320, and may be useful in leveraging the network device's sensing capability to detect surrounding threats.

### Example Security Applications of Network Device-centric MobiFlow

The network device-centric MobiFlow enables the security xApps on the nRT-RIC to assess the security of network devices, and leverages the network device's sensing capability to detect surrounding threats. The following examples describe some security applications driven by network device-centric MobiFlow records.

### Malicious Network Device Detection

Adversarial network devices may be established using COTS radio hardware and open-source software, which can further perform availability attacks on the RAN infrastructure and other network devices. Therefore, the fine-grained telemetry of specific network devices can help O-RAN operators identify potentially malicious network devices subscribed to the network, based on metrics such as abnormal traffic at the cellular control plane or user-plane (e.g., numerous RRC connection request messages sent to DoS a base station).

### Network Device-targeted Attack Detection

As a network device may be vulnerable to multiple external vectors, the network device-centric MobiFlow enables detection of malicious attacks towards a network device, perform diagnosis for anomalous activities, and identify root causes. For instance, network devices may be subject to spoofing attacks which may cause service outages. As such, the MobiFlow records among various network devices in the network can be cross-checked. In addition, other problematic scenarios such as malicious paging and roaming may be identified.

### Rogue Base Station Detection

In some aspects, crowdsourced measurement reports from network devices may be leveraged to detect rogue base stations that are proximate to the network devices. Since these measurement reports include various measurements of base stations such as location, physical signal strengths, and broadcast information, they may be leveraged as inputs for detection algorithms which identify abnormal statistics (e.g., unusual signal strengths and incorrect locations, and so forth).

Also, for example, the RAN-centric data may be converted into RAN-centric flow records 355. The RAN-centric data may include RAN-specific identifiers, aggregated statistics of subscribed network devices (e.g., counters tracking currently connected network devices and failure network devices in a history), measurement statistics (e.g., signal strengths and broadcast parameters), RAN-based traffic (e.g., E2 interface packets), timers, and/or RAN node states.

### Example Security Applications of RAN-Centric MobiFlow

The RAN-centric MobiFlow may be configured to drive various RAN-specific security tasks, such as some examples described herein.

### Malicious RAN Node Detection

The cloud-native deployment of O-RAN can result in security risks in RAN nodes. The abnormal traffic of RAN nodes may be utilized by the nRT-RIC to detect potential compromised RAN nodes that transmit malicious traffic to other RAN nodes or the RIC.

### RAN-Targeted Attack Detection

The aggregated measurement statistics may be utilized to identify malicious attacks targeting the RAN. For instance, malicious network devices may launch BTS depletion attacks to exhaust the resources of a single BS, further denying the service of all subscribed users. Additional similar attacks on the cellular data plane (e.g., malicious TCP/IP traffic) can be detected in a similar fashion.

Core-specific MobiFlow stream includes aggregated RAN statistics (e.g., active and inactive RAN nodes), core node status, core network traffic, etc. As the core network does not have a direct connection to the RIC, the core-centric MobiFlow records can be transmitted via the N2 and N3 interfaces (shown in FIG. 1) and reported from the CU nodes.

### Example Security Applications of Core-Centric MobiFlow

The core-centric MobiFlow records can drive various core-based security applications such as the detection of anomalous core network nodes and network diagnosis. For instance, core-related traffic can help diagnose anomalous activities such as authentication failure and security mode failure of a specific network device. Core-targeted attacks may also be detected (e.g., network DDoS and Diameter attacks), and compromised core network nodes may be identified. For example, with an introduction of several network features in 5G, such as network slicing, there may potentially be larger attack surfaces and new types of attacks (e.g., ML-based attacks) on the core network side.

In some embodiments, MobiFlow collector 360 may collect the network device-centric or RAN-centric flow records 355, and nRT-RIC 365 may generate fine-grained records. Also, for example, MobiFlow collector 360 may monitor L3 control-plane network packets that may be needed by the IDS, and a typical network device attachment may involve fewer (e.g., less than 20) control packets.

Generally, SecSM may be a security component that is compliant with the underlying SD-RAN, and may be configured to generate MobiFlow stream records. In some embodiments, SecSM may include a specialized E2SM specification that defines message structures and SecSM agents (e.g., agents located at both the network layer 305 and control layer 310). The SecSM agents may be configured to generate MobiFlow records and transmit them to application layer 315 (e.g., as E2-reports 370).

In some embodiments, application layer 315 may include xApps 380 (e.g., MobiExpert and other installed xApps). Generally speaking, a programming language for specifying protocols in event-driven environments may be used. For example, the programming language may be an object-oriented programming language, a scripting programming language, a functional programming language, and/or a combination thereof. As one illustration, PYTHON® may be used for malware analysis, penetration testing, and/or scanning. For example, a PYTHON®-based open source code for machine learning based intrusion detection system (e.g., IDS-ML) may be used. Also, for example, JAVA®, C, C++, and other programming language based code may be used for an intrusion detection system.

In some aspects, MobiExpert may be designed based on a Production-Based Expert System Toolset (P-BEST) language, which is generally used for intrusion detection (e.g., in mainframes, operating systems, network traffic, application logs, and for alert correlation). P-BEST features a decoupled architecture that separates detection mechanisms from the system implementation and also provides an efficient P-BEST language that facilitates production-based IDS rules to be translated into C programs. For instance, a P-BEST specification with 758 lines of code may be converted into over 4, 000 lines of C code by pbcc. The P-BEST language also enables programming of sophisticated rules to perform temporal and quantitative analysis for attack inference.

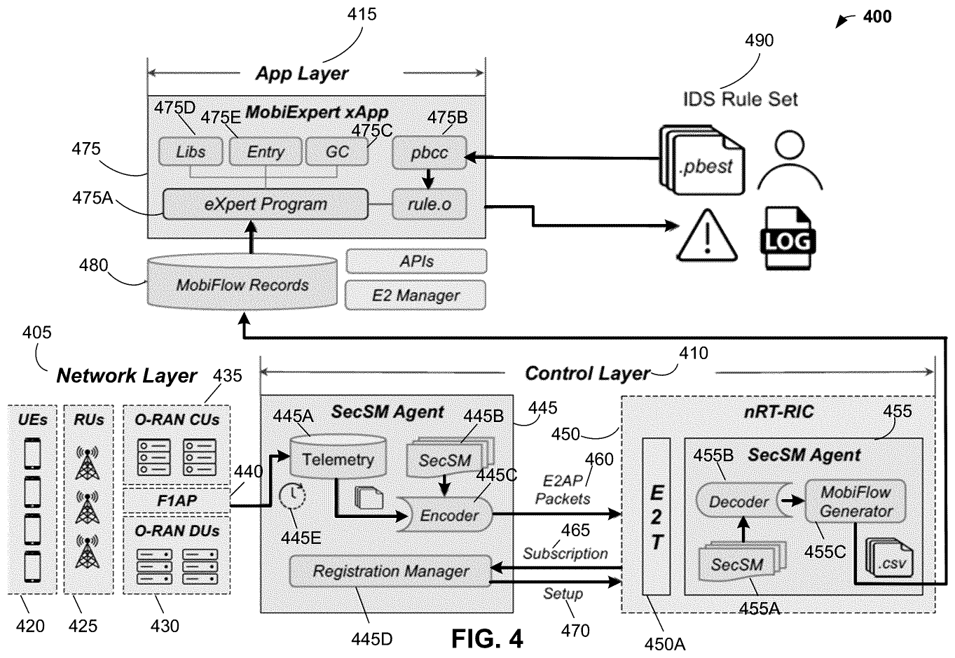

FIG. 4 depicts a detailed view of an example architecture 400 to generate a telemetry stream for monitoring a software-defined radio access network (SD-RAN), in accordance with example embodiments. Although the example architecture 400 is illustrated with reference to O-RAN, the techniques may be adapted in a general SD-RAN environment. The components in FIG. 4 may share one or more aspects in common with the components described with reference to FIG. 3.

As illustrated, network layer 405 may include components such as one or more network devices (e.g., user equipments (UEs) 420), one or more RUs 425, one or more DUs 430, and one or more CUs 435. The components of network layer 305 may follow various protocols of the SD-RAN (e.g., O-RAN). The network layer 405 collects network telemetry from the network components and exports MobiFlow records to the control layer 410. For example, network layer 405 may receive data comprising one or more network packets associated with the SD-RAN, wherein the one or more network packets include communications data between the one or more RUs 425 configured to provide radio access and one or more UEs 420. F1 interfaces (e.g., F1AP 440) may connect the one or more RUs 425, and the one or more DUs 430, to SecSM agent 445 in control layer 410.

In some embodiments, control layer 410 may include first SecSM agent 445 and nRT-RIC 450. In some embodiments, nRT-RIC 450 may include second SecSM agent 455. Generally speaking, SecSM enables O-RAN compliant interfaces that allow security-focused xApps (e.g., MobiExpert 475) to receive the necessary data-plane telemetry that can drive run-time security analyses across the mobile network. Accordingly, first SecSM agent 445 may incorporate multiple agents 445B that serve as plugins to extract telemetry 445A for both the RAN data and the control planes. SecSM may be configured to implement an E2 service model (E2SM) specification (e.g., in ASN.1 language) for the corresponding communication protocol (e.g., packet format for an indication message). In some aspects, SecSM may provide services such as (1) registration procedures (e.g., via registration manager 445D to manage subscription 465 and setup 470) between the E2 nodes and the xApps, and (2) telemetry collection (e.g., via telemetry 445A), and report via the standard E2 interface (e.g., using E2AP packets 460).

Initially, the E2 nodes (i.e., CUs 435 and DUs 430) and xApps 475 may perform registration procedures via the nRT-RIC 450. In some embodiments, registration manager 445D may be configured to facilitate the registration procedures. The nRT-RIC 450 may register an E2 node via an E2 Setup procedure 470. An xApp 475 subscribes to an E2 node via a RIC Subscription procedure 465.

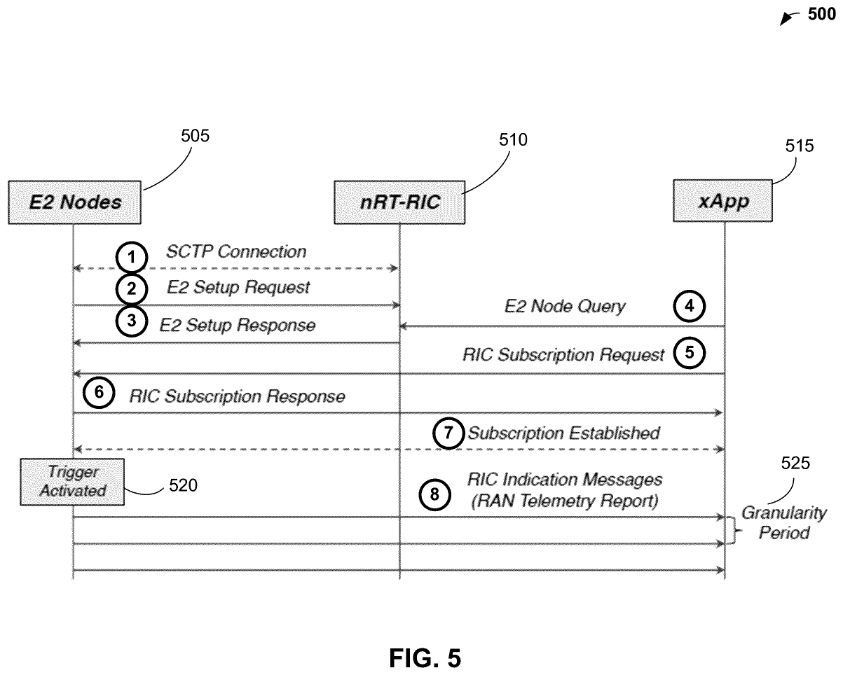

FIG. 5 illustrates an example workflow 500 for a setup procedure and a subscription procedure, in accordance with example embodiments.

### E2 Setup

The E2 setup procedure (e.g., setup 470) may begin at step 1. Step 1 may involve establishing an SCTP connection between E2 node 505 and nRT-RIC 510.

Step 2 may involve an initiation of an E2 Setup Request by E2 node 505 to nRT-RIC 510. The E2 Setup Request may convey the meta information and capability of E2 node 505 and may include elements such as: (a) a RAN function definition that describes E2 node 505 with its supported E2SM ID, (b) an E2 node list that includes meta information such as the public land mobile network (PLMN) ID, (c) an event trigger style that defines the supported conditions for when E2 node 505 should report to the nRT-RIC 510. For SecSM, the reports may be periodic reports and/or event-based reports, and (d) a report style that declares the telemetry that can be collected from E2 node 505.

At step 3, upon receiving a setup message, nRT-RIC 510 may rely on either an E2 Setup Response or an E2 Setup Failure (not shown in FIG. 5) to inform the outcome.

### RIC Subscription

The RIC subscription procedure (e.g., subscription 465) may begin at step 4. For example, after deployment, at step 4, xApp 515 hosted by nRT-RIC 510 may query the connected E2 nodes for their RAN function definitions and identify the nodes to subscribe to. Some of the subscription types based on the E2 interface operations may include Report, Insert, Control, and Policy. For example, SecSM may use the Report subscription type of the E2 Node to collect the data.

At step 5, to begin a subscription, an xApp 515 may initiate a RIC Subscription Request to the E2 nodes of interest (e.g., E2 Node 505) and select the appropriate event trigger and report style.

At step 6, E2 Node 505 send the RIC Subscription Response to xApp 515, and at step 7, a subscription may be established.

### Telemetry Collection and Reporting

The RAN- and network device-related telemetry (e.g., telemetry 445A of FIG. 4) may be collected by a SecSM agent deployed on the CUs and DUs. For example, first SecSM agent 445 may be an independent and vendor-agnostic plugin running in parallel with the normal CU and DU processes. Also, for example, first SecSM agent 445 may provide a standardized F1 application protocol (F1AP) interfaces (e.g., F1AP 440 of FIG. 4), that may handle various basic procedures (e.g., network device context setup and RRC message relay).

Based on the subscription type, in the event of a trigger activation 520, an RIC indication message may be sent to xApp 515. Granularity period 525 may be configured to correspond to an amount of time during which data is collected prior to sending an indication message. Granularity period 525 may depend on UE 505, the CUS, DUs, types of subscriptions, types of threat attacks and/or anomaly detection, and so forth.

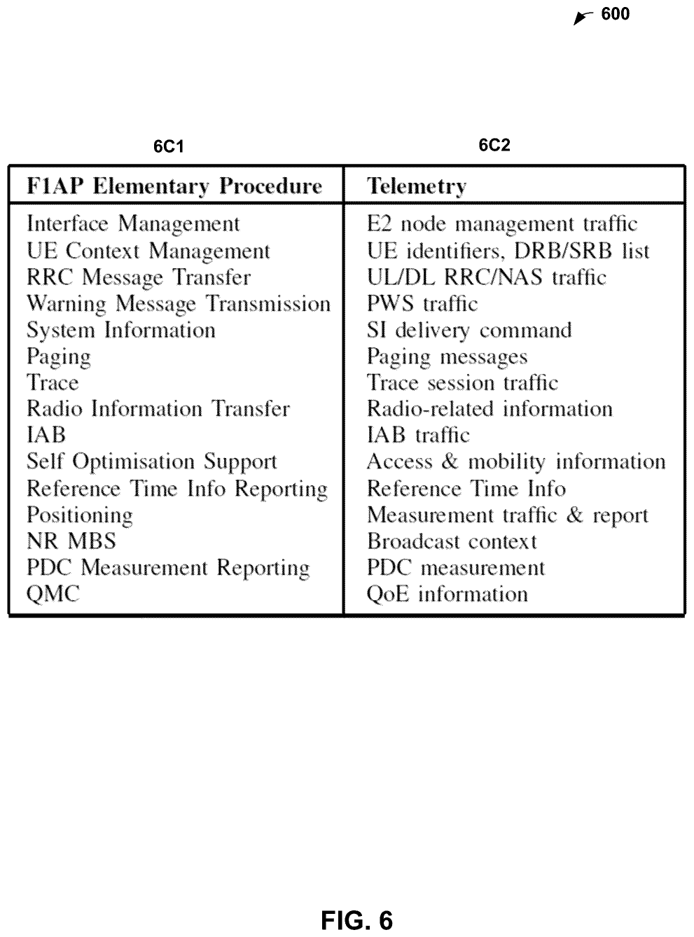

FIG. 6 illustrates a table 600 summarizing example data, in accordance with example embodiments. For example, column 6C1 F1AP telemetry, lists an F1AP elementary procedure and column 6C2 lists the associated data that may be collected. For example, the telemetry available from the F1 Application Protocol (F1AP) is shown, which could be collected to extend MobiFlow's feature set. Based on 3GPP TS 38.473, F1AP provides a standard interface for to interconnect CU and DU of an eNB/gNB. All F1AP functions are categorized into different elementary procedures, such as network device context setup and RRC message transfer. For this reason, F1AP is implemented in various CU and DU implementations (e.g., OpenAirInterface), and thus telemetry may be extracted by instrumenting this interface. Furthermore, MobiFlow's feature set may be expanded, such as to support other protocols (e.g., paging) for diagnosis or exploit detection.

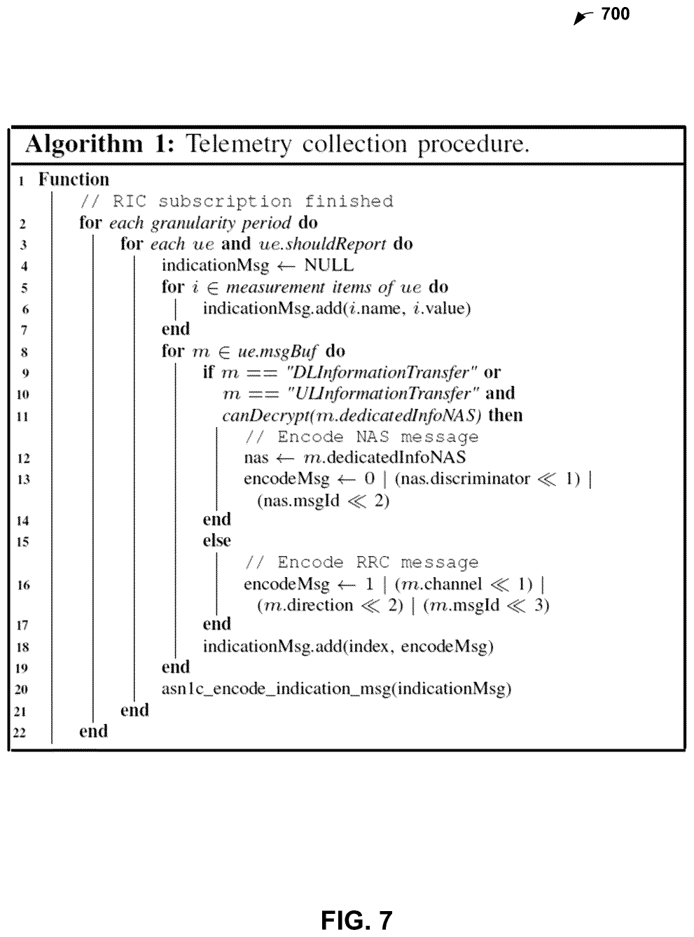

FIG. 7 displays an example algorithm 700 for data collection, in accordance with example embodiments. Some aspects of algorithm 700 may be discussed with reference to FIGS. 4 and/or 5. Based on the event trigger defined in an E2 setup message during subscription, the SecSM agent (e.g., first SecSM agent 445) may collect telemetry 445A per granularity period (e.g., 100 ms at a near real-time scale) and aggregate them into an indication message. The first SecSM agent 445 may maintain a buffer for a given subscribed network device of the UEs 420, and initiate a report when the given network device has been updated (e.g., a new state or a control traffic). For the given network device to be reported, one or more measurement elements (e.g., as defined in the SecSM specification) may be encoded into an indication message (e.g., to include names and values). To reduce the payload size, the network device's RRC and NAS message names are encoded into an integer value.

At line 8, the algorithm may be configured to iterate over each RRC message that has not been reported since the last granularity period. As NAS messages may also be relayed in the RRC traffic, the algorithm may be configured to check if the message carries a NAS payload (e.g., dedicatedInfoNAS) and may be decrypted. As indicated in lines 9-14, in the event that the message carries a NAS payload and can be decrypted (e.g., by decoder 455B), a discriminator and message ID associated with the NAS payload may be extracted to encode a NAS message (e.g., by encoder 445C). As indicated in lines 15-17, in the event that the RRC message does not relay a NAS payload, a channel information (e.g., DCCH or CCCH), direction (e.g., uplink or downlink), and message ID for the RRC message may be used as different bits to encode the indication message (e.g., by encoder 445C). For example, to distinguish RRC and NAS messages, a single header bit. For example, line 13 illustrates an NAS message encoded with a 0 bit, and line 16 illustrates an RRC message encoded with a 1 bit.

Referring again to FIG. 4, in some embodiments, after the telemetry 445A may be loaded into an RIC Indication Message, and may be encoded (e.g., by encoder 445C) into an ASN.1 structure based on the SecSM E2SM specification. The indication messages may be embedded in standardized E2AP packets 460 and delivered to nRT-RIC 450. In some embodiments, SecSM agents 445B may report one such E2AP packet 460 per granularity period.

### Example Telemetry Stream (MobiFlow)

The telemetry 445A collected and reported from the F1AP interfaces 440 may lack certain fine-grained parameters that facilitate security analysis. For instance, telemetry 445A may not include global statistics and the network device states at the packet level (e.g., whether the network device is connected and communication is signed and encrypted). Thus, a second SecSM agent 455 may be deployed at nRT-RIC 450 to convert this reported telemetry into a fine-grained telemetry stream (e.g., MobiFlow stream records). This process may involve additional procedures such as state transformation and statistics aggregation. As a result, it is preferable that MobiFlow record generation not be performed on the latency sensitive data plane due to performance concerns.

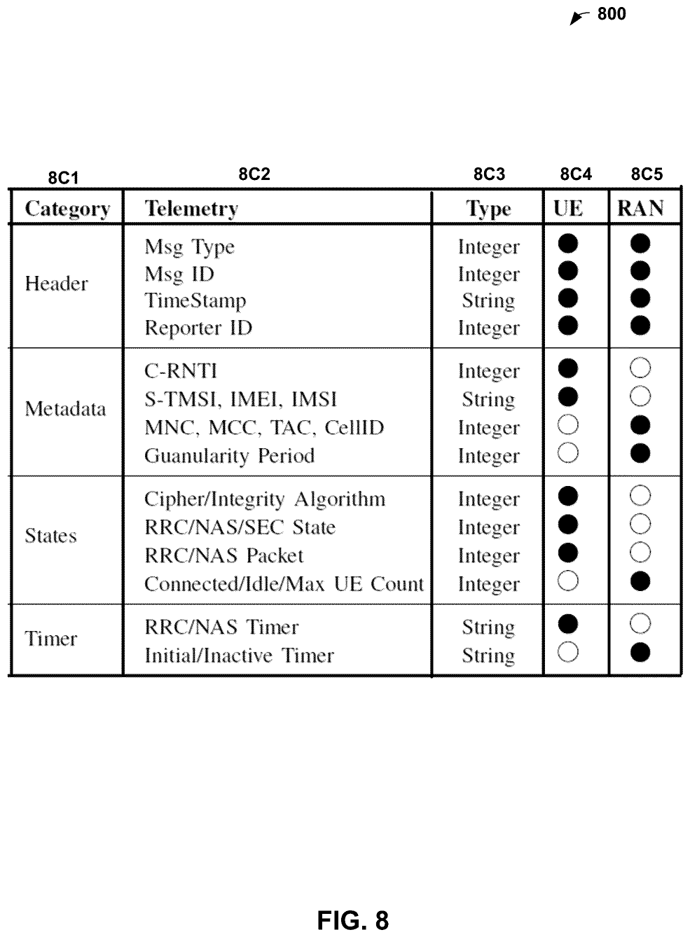

FIG. 8 illustrates a table 800 with example data utilized by MobiFlow stream records, in accordance with example embodiments. Generally speaking, MobiFlow may be defined as various structures. As shown in table 800, there may be two types of MobiFlow to describe the fine-grained status of the network device and RAN, respectively. Both types of MobiFlow may begin with a common header to indicate attributes such as the message type, ID, timestamp, and reporter ID.

Column 8C1 lists a category, such as “Header,” “Metadata,” “States,” and “Timer.” Column 8C2 lists the corresponding data. For example, the category “Header” may be associated with message type, message ID, a timestamp, and a reporter ID. Column 6C3 lists the type of data for each telemetry. For example, while message type, message ID, and reporter ID are integers, the timestamp is a string. Column 8C4 indicates whether the telemetry is collected from a network device. A filled-in circle indicates that the telemetry is collected from the network device (e.g., network device-centric telemetry), whereas an empty circle indicates that the telemetry is not collected from the network device. Likewise, column 8C5 indicates whether the telemetry is collected from a RAN. A filled-in circle indicates that the telemetry is collected from the RAN (e.g., RAN-centric telemetry), whereas an empty circle indicates that the telemetry is not collected from the RAN.

Referring again to FIG. 4, generally, a given network device of the UEs 420 may use various identities during cellular network connections. Accordingly, the network device-centric telemetry may include temporary identifiers, including Cell Radio Network Temporary Identifier (C-RNTI) and Serving Temporary Mobile Subscriber Identity (S-TMSI), as well as permanent identifiers, such as International Mobile Equipment Identity (IMEI) and IMSI/SUCI, may be tracked. For instance, C-RNTI allows the identification of a unique RRC connection between a network device and the RAN, and S-TMSI identifies a unique NAS session between a network device and MME/AMF. In some embodiments, the fine-grained network device status, including RRC, NAS, and security states, as well as the protection algorithms, may be inferred at packet level. The timing information may be tracked via timers (e.g., timer 445E) that indicate when the network device starts and ends a particular RRC/NAS session.

As described previously, a RAN-centric telemetry can provide near real-time aggregated statistics of the RAN (i.e., a physical base station). Accordingly, RAN-centric telemetry may include physical RAN identifiers, such as Mobile Country Codes (MCC) and Mobile Network Codes (MNC). The RAN states may include statistics, such as a current number of connected and idle network devices, as well as a maximum capacity for the RAN. Similar to the network device-centric telemetry, timers (e.g., timer 445E) may record and track the life cycle of the RAN.

Based on the MobiFlow definition, second SecSM agent 455 at nRT-RIC 450 may convert the telemetry into a telemetry stream (e.g., fine-grained MobiFlow stream records). For example, the encoded indication message may be decoded by decoder 455B. Like first SecSM agent 445, second SecSM agent 455 may include several agents 455A. As the reported telemetry is aggregated within a granularity period, MobiFlow generator 455C may convert the aggregated data into packet-level stream records. Since not all measurements may be available from the RAN data plane, additional computations and inferences may be performed to generate the MobiFlow records (e.g., as illustrated in table 800 of FIG. 8).

In some embodiments, fine-grained state transitions may be utilized. Such states may enable analysts to accurately identify the status at a packet-level granularity (e.g., a network device completes security context setup after transmitting a SecurityModeComplete Message). As defined in 3GPP TS 24.301 and 38.331, fine-grained protocol states may be defined as finite-state machines (FSMs) and transit upon receiving certain control messages. For example, the NAS protocol can maintain states such as EMM_REGISTERED to indicate an established EMM context with the core. Accordingly, second SecSM agent 455 may be configured to maintain a copy of network device and RAN states and perform state inference using specification-defined FSMs. In some embodiments, a security state may be set to track whether a network device has completed the security mode procedures.

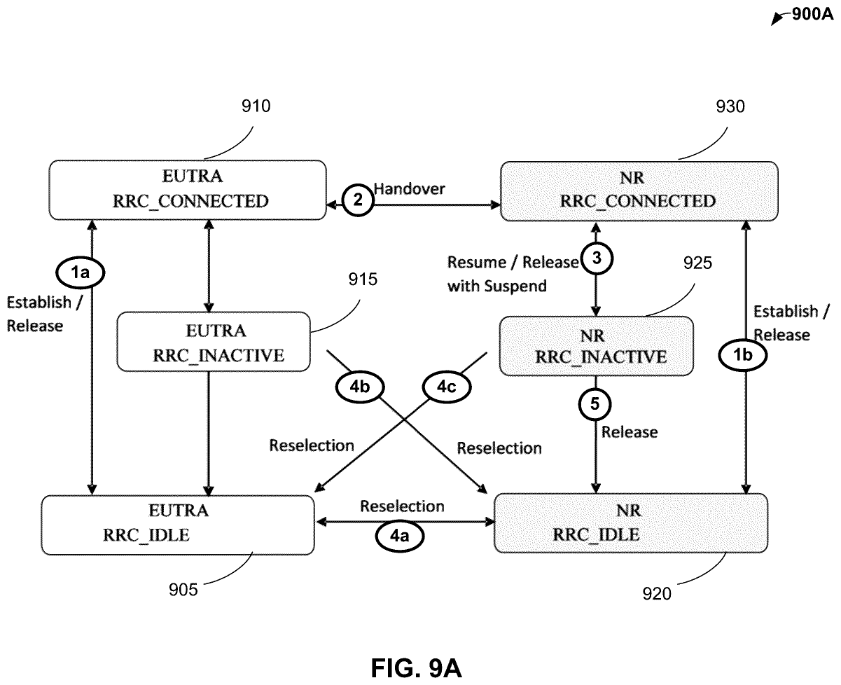

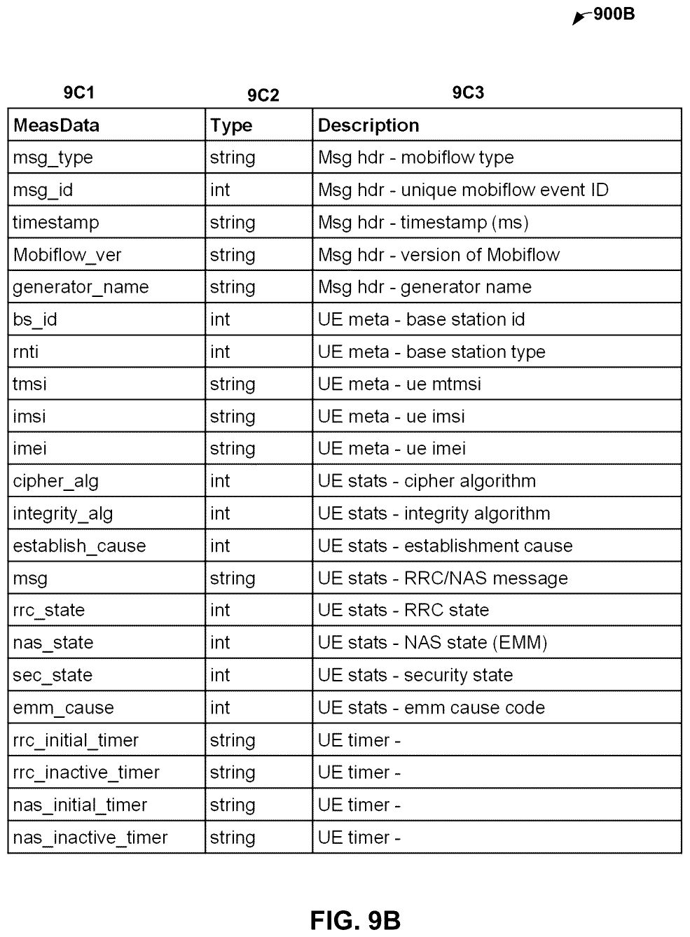

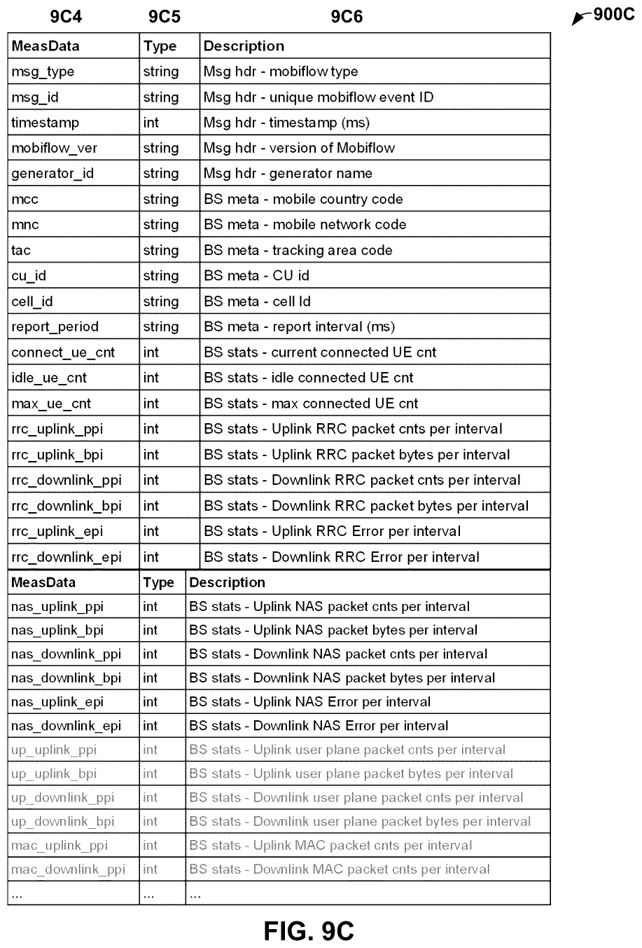

FIG. 9A illustrates an example finite-state machine 900A for a user equipment, in accordance with example embodiments. States 905, 910, and 915 correspond to Evolved UMTS Terrestrial Radio Access (EUTRA) communication states. States 920, 925, and 930 correspond to a new radio (NR) state. At state 905, the network device may be in an RRC_IDLE state in EUTRA. At step 1a, a first establish/release protocol may transition the network device from state 905 to state 910 where the network device may be in a RRC_CONNECTED state in EUTRA. In some embodiments, the network device may transition from state 910 to state 915 where the network device may be in a RRC_INACTIVE state in EUTRA, and subsequently, the network device may transition from state 915 to state 905. In some embodiments, the network device may transition from state 915 back to state 910.

In some embodiments, when the network device is in state 905, at step 4a, a first reselection procedure may transition the network device from state 905 to state 920, where the network device is in a RRC_IDLE state in NR. Similarly, when the network device is in state 915, at step 4b, a second reselection procedure may transition the network device from state 915 to state 920.

At step 1b, a second stablish/release protocol may transition the network device from state 920 to state 930 where the network device may be in a RRC_CONNECTED state in NR.

In some embodiments, when the network device is in state 910, at step 2, a handover procedure may transition the network device from state 910 to state 930, where the network device is in a RRC_CONNECTED state in NR. Also, for example, the network device may transition from state 930 to state 910.

In some embodiments, at step 3, a resume/release with Suspend procedure may transition the network device from state 930 to state 925 where the network device may be in a RRC_INACTIVE state in NR. At step 5, a release operation may transition the network device from state 925 to state 920. In some embodiments, the network device may transition from state 925 back to state 930.

In some embodiments, when the network device is in state 925, at step 4c, a third reselection procedure may transition the network device from state 925 to state 905.

Referring again to FIG. 4, in some embodiments, first SecSM agent 445 may be configured to maintain timers (e.g., timer 445E) to track the start and end of a session for each UE and RAN. For example, once a network device enters a RRC_CONNECTED or RRC_INACTIVE state, a current timestamp may be assigned to the RRC initial or inactive timer, respectively.

In some embodiments, for RAN-centric MobiFlow records, MobiFlow generator 455C may determine aggregated network device statistics when network device states are updated. For example, an active network device counter may be increased when a new network device enters the RRC_CONNECTED state. Generally, an update of RAN states may notify the agents 455A to generate and report RAN-centric MobiFlow stream records to the xApps 475. For example, MobiFlow generator 455C may send MobiFlow stream records to the application layer 415, and the MobiFlow stream records may be stored in a MobiFlow records database 480.

FIG. 9B illustrates a table 900B with example aggregated data for a user equipment, in accordance with example embodiments. Column 9C1 lists a measurement collected, column 9C2 lists a type of data (e.g., integer or string) associated with the measurement in column 9C1, and column 9C3 provides a description associated with the measurement in column 9C1.

FIG. 9C is a table 900C with example aggregated data for a RAN, in accordance with example embodiments. Column 9C4 lists a measurement collected, column 9C5 lists a type of data (e.g., integer or string) associated with the measurement in column 9C4, and column 9C6 provides a description associated with the measurement in column 9C4.

### Application Layer

Referring again to FIG. 4, application layer 415 serves as another component that hosts the xApps, such as MobiExpert xApp 475. In some embodiments, MobiExpert xApp 475 may be configured to run a standalone eXpert program 475A that takes the MobiFlow stream records (e.g., stored in a MobiFlow records database 480) as input and produces alerts and logs in the networks. In some embodiments, MobiExpert xApp 475 may incorporate one or more components such as (1) a pbcc translator 475B, (2) a P-BEST routine, (3) a garbage collection (GC) routine 475C, and (4) a set of static libraries (e.g., Libs 475D).

In some embodiments, the pbcc translator 475B may be configured to convert a specification file (e.g., rule.pbest) written in a production language (e.g., P-BEST production rule language) into a functional C program. Through the pbcc translator 475B, elements in the P-BEST domains (e.g., facts and rules) may be translated into corresponding C variables, structures, and functions. The converted C program may be linked to the main P-BEST routine during compilation.

In some embodiments, the main eXpert C routine may be configured to handle external inputs and the context switch between C and P-BEST domains. Generally, developers may create an entry function (e.g., Entry 475E) that reads MobiFlow records (e.g., from a CSV file, a sparse binary file, a JSON file, and/or MobiFlow records database 480), inserts it into the fact pool using the library APIs associated with Libs 475D, and the control may be handed over to an internal inference engine. This internal inference engine may be configured as a forward chaining system that can iteratively evaluate and activate (e.g., if rule conditions are satisfied) rules on asserted facts until the fact pool is stable (i.e., no facts in the current fact pool bind to the ruleset). Subsequently, the control may be switched back to the C domain for the next cycle.

In some embodiments, while programming with P-BEST to generate new facts, the corresponding garbage collection rules (e.g., GC 475C) may be defined. This routine prevents unused facts from consuming memory resources, and/or removes facts that no longer require evaluation, as developers working with C programs generally manage dynamically allocated objects. In some aspects, the objective of GC 475C may be similar to invoking the “free( )” function in C, and provides programmers with fine-grained semantic control of the fact-purging criteria. For example, GC 475C may commonly integrate time references to perform interval-based garbage collection or may purge facts based on a state of other facts in the global pool.

In some embodiments, P-BEST libraries, Libs 475D, may include a set of static libraries (e.g., libpb.a) linked during compilation and can be configured to provide P-BEST management APIs. For example, in order to insert a new fact into the system, the eXpert routine may invoke an “assert( )” function with the fact instance and then transfer control to P-BEST by calling an “engine( )” function.

### Production Rule Language

The production rule language may include “facts” and “rules”, where a fact generally refers to a piece of knowledge in a fact pool, and a rule generally refers to a user-defined logic (e.g., IDS Rule Set 490) to create, modify, and/or delete some facts by evaluating the existing facts. In some embodiments, a P-BEST production rule may be formulated as:

$$\frac{∃ S ∧ {ϕ}_{1} ∧ {ϕ}_{2} … ∧ {ϕ}_{n}}{{S}^{′} = S ⋃ {ψ}_{1} ⋃ {ψ}_{2} … ⋃ {ψ}_{n}} \qquad ( Eqn . 1 )$$

where ϕ1 to ϕn express the antecedents, Ψ1 to Ψn express the produced consequences, and S to S′ represent the transition from the previous state to a new state of the fact pool.

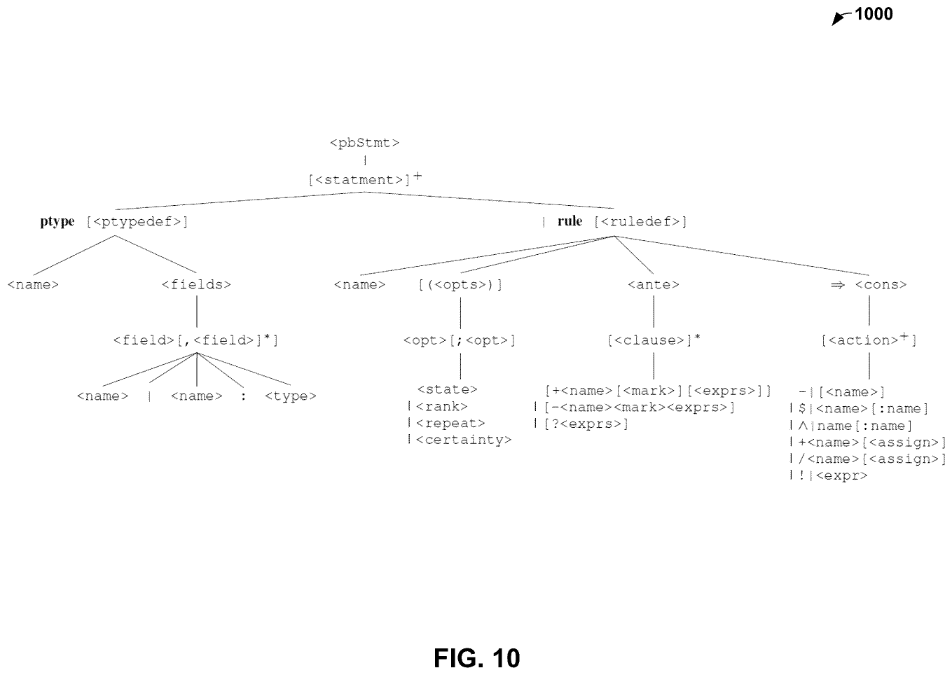

FIG. 10 illustrates an example abstract syntax tree 1000 for P-BEST language, in accordance with example embodiments. For example, abstract syntax tree 1000 illustrates how facts and rules may be defined as “ptypes,” and “rules”.

Prior to creating rules, a user may declare certain data structures as pattern types, or ptypes. A ptype generally includes multiple data fields of different types (e.g., integer and string) and can be converted into a C structure by the pbcc (e.g., pbcc 475B). A ptype can be mapped to an event or a fact that may be evaluated by user-defined rules. For instance, a MobiFlow record or an attack event can be defined as a ptype so that a rule can evaluate MobiFlow records to produce attack events. The P-BEST language allows a user to create, modify, and delete a ptype instance with corresponding P-BEST operands (e.g., +, /, and −). A fact can also be masked ($) or unmasked (Λ) to prevent itself from being repeatedly evaluated by a specific rule.

A P-BEST production rule may be written as an “IF . . . THEN . . . ” structure. A P-BEST rule can be defined via the rule keyword and may use a “⇒” symbol to connect the antecedent and the consequent. When a rule is triggered, the conditions in the antecedent may be evaluated sequentially, and corresponding consequent statements may be executed if pertinent conditions (e.g., all conditions) are satisfied. The P-BEST language generally supports a wide range of operations, including logical and arithmetic computation of various data types, as well as invoking (e.g., by using a “!” operand) standard library functions in C (e.g., strcmp( )) or user-defined C functions via a C-language bridge. A rule may be assigned with properties, such as <state> (e.g., enabled or disabled) and <rank> (e.g., a priority in execution order among other rules).

### Example Anomalous Activities

An attacker or adversary may attempt to bring down a higher generation network, for example, during some mission critical moments in time. For example, an attacker may use one or more low-cost approaches to take down 4G and 5G networks by directly attacking the base station device link clear protocol (e.g., the RRC protocol). It is desirable to detect such attacks in near real time. Also, for example, it is desirable to filter and triangulate the attacker as quickly as possible. However, adversaries may generally prefer attacks that are targeted and produce fewer indicators. Accordingly, there may be situations where specific devices, such as a 5G camera, may need to be removed from a network at a crucial moment in time. The IDS described herein may be configuured to generate alerts that can facilitate such timely interventions.

Location tracking can be a two way threat. An adversarial actor may prefer to use mobile skills to track the movements of mobile users who transit an area. Some 4G and 5G link protocols may use an IMSI as a method for aliasing the identities of wireless devices, and this can make geo-tracking challenging in regions with a lot of transient devices. However, recently published methods illustrate vulnerabilities that can allow an adversarial actor to stealthily extract user device locations and permanent identifiers, such as IMSIs and IMEIs. Such attack approaches are sophisticated and less detectable than the IMSI catcher attack. These vulnerabilities spotlight some SDR strategies that involve a technique called adaptive signal overshadowing. Generally, it is desirable that operators detect signal overshadowing attacks that occur between a base station and users, and ideally warn the users when there are signs that they are being targeted. The exposure of permanent device identifiers may be fixed as a vulnerability by encrypting their transmission using a new encrypted wrapper called a subscription concealed identifier (SUCI), specifically designed to catch threats such as an IMSI catcher.

The SUCI catcher attack demonstrates how to verify whether a specific known individual 5G device, including its specific IMSI, are in the proximity of the SUCI catcher despite the encryption of IDs. The attack may be scaled to demonstrate an ability to detect multiple devices (e.g., up to 500 known devices) within a 60-second test window. Monitoring the base stations may enable generating of useful patterns for distinguishing normal devices from unknown rogue network devices or malicious SDR's. For example, base station engagements among homogeneous networks may be compared to examine outlier device patterns that can facilitate identification of rogue network devices that attack or disrupt the 5G link and authentication procedures of other network devices. In order to protect a higher generation cellular network and users thereof, it may be preferable to initiate attack detection analysis as soon as a device attempts to establish a link.

Some recent attacks have focused on a mobile device as it progresses to establish an authenticated session with the base station. Attacks may occur at the session establishment and/or device authentication protocol steps, whereby an attacker does not need to establish an authenticated connection into a 5G network. For example, in a contested region, an attacker can use a low-cost SDR within earshot of the base station or the victim's phone.

These attacks against an SD-RAN open source implementation may be simulated. In the SD-RAN data plane design, service models may be used to generate low level telemetry that can be used to track the internal RRC/NAS state transitions. For example, O-RAN's existing SD-RAN implementation includes five reference service models that can be used to drive O-RAN's performance analytics and network controls including hand-over management and slicing. However, existing SD-RAN service models are not configured to capture the fine-grained state transitions and aggregate statistics that can drive effective attack detection.

Notably, attacks targeting cellular networks have risen in complexity and stealthiness over time, due to an availability of inexpensive commercial-off-the-shelf (COTS) software-defined radios (SDRs) and open-source cellular software stacks that simplify execution of cellular-infrastructure attacks. For instance, it can be relatively inexpensive to build a fully controllable attack device (e.g., a rogue network device or base station). Generally, the RAN and its connected network devices may be vulnerable to numerous attacks from various classes of (active) adversaries, including malicious network devices, fake base stations, Man-in-the-Middle (MiTM) attackers, and surgical signal injectors. Many attacks may be transparent to users and occur very early before the network device establishes a reliable data connection with the RAN (e.g., by injecting a sequence of malicious control signals), making them challenging to detect in practice. These exploits on the RAN and network devices may have adverse consequences, such as service outages, resource depletion, and/or privacy leakage.

For illustrative purposes, some example cellular attacks and their impact on security and privacy are described herein. However, this is not an exhaustive list.

### Adversarial Network Device

In an adversarial network device attack, an attacker can set up a malicious network device by using a valid subscriber network identity (e.g., SIM) and a cellular device (e.g., a smartphone). In some cases, the attacker may configure an adversarial network device based on an open-source cellular stack on an SDR to achieve fine-grained control over protocol messages. Using such an adversarial network device, an attacker can perform DoS attacks targeting either the RAN (e.g., radio jamming) or another network device in the network (e.g., TMSI replay).

### Fake Base Station

Fake base station (FBS) attacks leverage a lack of verification of an authenticity of base stations. Such attacks are generally directed to stealing user data, such as an International Mobile Subscriber Identity (IMSI) in prior GSM (2G) networks. As in the 5G release, FBS attacks may be mitigated by introducing IMSI encryption. However, FBS can also be set up for many other control message attacks, and may cause denial-of-service and/or privacy leakage in network devices.

### MiTM Attacker

A MiTM attack relay functions by impersonating a legitimate base station (BS) towards a victim network device and a legitimate network device towards a victim BS. As a result, two SDRs are required to launch the attack. A MiTM attacker can then replay, eavesdrop, and/or inject messages in the traffic. For instance, the attack can exploit the lack of integrity protection for user-plane messages to redirect domain name system (DNS) requests of the victim network device. Generally, MiTM attacks share similar root causes with FBS attacks.

### Signal Injector

A signal injector attack allows adversaries to use an SDR to inject malicious signals into cellular traffic while maintaining high stealthiness (i.e., with slightly higher signal strength). Such signal injection (or overshadowing) attacks can be further exploited to leak a user's identity (e.g., IMSI in LTE network) or may be DoS specific network device.

### Compromised Core Network

A compromised core network node can cause security and privacy risks, such as by exposing sensitive network device information or cryptographic keys. As in 5G, the core network may impose actual security threats due to 5G-specific design choices such as network slicing and Network Function Virtualization (NFV).

### Passive Eavesdropper

A passive sniffer may eavesdrop on an uplink or downlink traffic for privacy attacks such as IMSI stealing and user tracking in LTE networks. The privacy information may be inferred from the paging messages, the synchronization procedure, and/or from side-channel information.

### Example Applications

The techniques described herein may be used to monitor, track and/or detect security misconfigurations that may indicate attacks involving network devices and base stations operating in an SD-RAN environment, detect faults and failures of the network devices and base stations, detect violations of a service level agreement (SLA), and/or detect a wide range of significant administratively relevant events such as security threats. Also, for example, the techniques may be used to detect non-compliance of devices. For example, detect whether a device is using an appropriate encryption protocol that is compliant with the network.

Generally, the data may include state transitions that are relevant to layer 3 and also aggregate statistics that can indicate threats, faults, failures, and/or anomalies. For example, data may be collected and aggregated with respect to operations of the network devices and base stations, and faults and failures may be detected by comparing the aggregated data with baseline data. For example, the aggregated data may indicate that a given device has a latency that deviates from a baseline latency. Also, for example, the aggregated data may indicate that a given device has a power consumption that deviates from a baseline power consumption. As another example, the aggregated data may indicate that a given device is transmitting data packets that include network data that deviates from a baseline network data. For example, the network data may include modified addresses, modified routing information, and so forth. As another example, the aggregated data may indicate anomalous network activity such as jitter, packet loss, non-availability of one or more network resources, and so forth.

In a network environment, various software components related to SLAs may be embedded within the network devices and base stations. The software components may provide access to the network devices, and data collected from such software components may be used to assess a performance of the network devices, monitor the network devices for compliance with one or more provisions of the SLA, detect violations of one or more provisions of the SLA, assess a quality of service (QoS), and so forth.

As an example, the telemetry stream may indicate that the base station is being impacted and is no longer able to meet one or more provisions of an SLA because of an inability to deliver bandwidth. As a result, new devices are not able to connect to the base station. An actual impact may be based on the aggregated data collected on an interval basis. For example, the aggregated data may be from 30 second intervals and may indicate a number of uplink counts, types of network packets, an amount of bandwidth, a number of NAS packets, and so forth. Such data can indicate whether there is a sudden spike in network traffic, a sudden drop in packets, and so forth. This may indicate a failure of network devices to communicate with one another. Accordingly, whereas the state transitions may indicate an attack on the base station, the interval-based aggregated statistics monitoring can indicate that the attack impaired the base station.

Accordingly, security analysis and fault recovery provides perspectives of both what may be happening at a device level for each base station, and also an overall behavior of the RAN.

The intrusion detection system described herein may be sometimes referred to as 5G-SPECTOR or Spector. Although the implementations are described in the context of 5G, similar techniques and considerations apply to higher generation SDNs. In some embodiments, a SDRAN-in-a-Box (RiaB) may be used, which is an O-RAN compliant platform with basic RIC services and xApp SDKs. Based on this platform, an example implementation may include the MobiExpert xApp and an example control plane design (SecSM and MobiFlow), as described herein. For the data plane, an OpenAirInterface (OAI) radio software suite for the CU, DU, and network device may be adopted. The core network may be the ONF's Open Mobile Evolved Core (OMEC), a LTE EPC.

An example prototype of MobiExpert may be implemented based on seven example attacks (including their variants). These example match the threat model described herein.

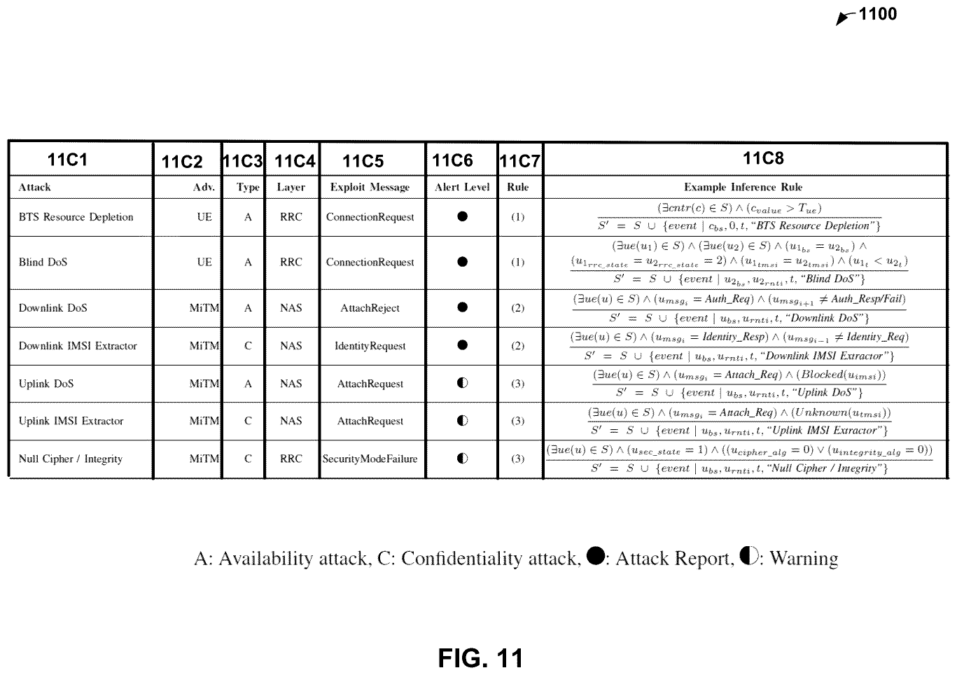

FIG. 11 illustrates a table 1100 with results of an implementation of an intrusion detection system based on example attacks, in accordance with example embodiments. Column 11C1 lists an attack, column 11C2 lists a type of adversarial attack (e.g., adversarial network device or MiTM), column 11C3 indicates whether the attack type is an “A” for an availability attack, or a “C” for a confidentiality attack. Column 11C4 indicates the layer (e.g., RRC or NAS). Column 11C5 lists the associated exploit message (e.g., Connection Request, Attach Reject, etc.). Column 11C6 indicates the alert level. For example, a filled-in circle indicates a reported attack, whereas a partially filled-in circle indicates a warning. Column 11C7 indicates which rule is being used, and column 11C8 displays an example inference rule in the P-BEST language for implementing the associated attack detection. For example, based on the attack listed in column 11C1, a P-BEST rule specification may be configured with 758 lines of code composed of 33 rules with 13 self-defined ptypes. Also, for example, these P-BEST specifications may be translated into over 4, 000 lines of C code by the pbcc. The implemented rules are based on certain anomalies and may be categorized into three rule sets for the seven attacks, as described below. Column 11C7 indicates the rule set (e.g., (1), (2), or (3)) that is applied to a given attack.

### Abnormal Quantity (AQ) Rule Set (1)

Detection of some attacks requires quantitative reasoning on accumulated events, such as BTS resource depletion. Accordingly, a first set of rules may be defined to generate anomalous events based on certain criteria and counters may be used to track them. When the counters reach an adjustable threshold, the rule set is configured to conclude and report an event.

### Abnormal Message (AM) Rule Set (2)

Some attacks may be detected based on abnormal message sequences of network devices (also viewed as protocol state-machine bugs). As such, this rule set can detect MiTM attacks that manipulate unprotected messages. For instance, an unsolicited IdentityResponse message is likely caused by the injection of an IdentityRequest message to extract IMSI in plain text.

### Abnormal State (AS) Rule Set (3)

This rule set detects whether certain state parameters are abnormal. For instance, a null ciphering or integrity attack triggers a network device into limited service mode with no cipher and integrity protection after security context establishment. In some embodiments, these states may be checked at run-time to infer such a malicious event.

### Example Intrusion Detection Rules

As described herein, P-BEST and MobiFlow may be used to create IDS rules. Some high-level representation of inference rules are provided in column 11C8 of FIG. 11. However, these are provided for illustrative purposes. Generally, the IDS rules may be different based on the telemetry stream and/or the programing language used.

### Detecting BTS Resource Depletion Attacks

In a BTS resource depletion attack (e.g., first row in column 11C1 of FIG. 11), a malicious network device exploits an unprotected RRC ConnectionRequest message, which allows the malicious network device to create massive fabricated RRC connections with random C-RNTIs to perform DoS attacks on the target BS. Specifically, the malicious network device restarts a new RRC session upon receiving a NAS AuthenticationRequest.

An example threshold-based detection approach may rely on an observation that each fabricated RRC connection is released after the T3460 timer in an MME/AMF expires after waiting for the AuthenticationResponse from the network device. Accordingly, such a malicious connection generally lasts for a few seconds, and thereby creates a distinguishing feature to identify it among other normal network device connections. The network device created by such a fake connection may be referred to as a transient network device or transient user equipment, t_ue, and counters, cnt, may be maintained for each BS to track the accumulated transient network devices in history. These two data types may be defined as ptypes in P-BEST. Based on the definitions, a set of rules for attack inference may be created. Initially, when a BS first detects a transient network device, the following rule may be triggered:

$$\frac{( ∃ ue ( u ) ∈ S ) ∧ ( {u}_{{t}_{2}} - {u}_{{t}_{1}} < {T}_{t} ) ∧ ( ∄ cnt ( c ) ∈ S ) ∧ ( {c}_{bs} = {u}_{bs} )}{{S}^{′} = S ⋃ \{ t\_ue \vert ( {u}_{rnti} , {u}_{bs} , t ) \} ⋃ \{ cnt \vert {u}_{bs} , 1 \}} \qquad ( Eqn . 2 )$$

The rule in Eqn. 2 can detect a transient network device based on the timers in MobiFlow records, as illustrated in table 800 of FIG. 8, by subtracting the inactive RRC timer (ut2) from the initial RRC timer (ut1). If the connection expires within a user-defined threshold Tt, a transient network device counter may be created as 1. Similarly, if a BS has transient network devices in the past, another rule may be triggered to increase the transient network device counter by 1. Next, when the transient network device counter of the BS, c_value, exceeds a threshold T_ue, an event may be reported:

$$\frac{( ∃ cntr ( c ) ∈ S ) ∧ ( {c}_{value} > {T}_{ue} )}{{S}^{′} = S ⋃ \{ event \vert {c}_{bs} , 0 , t , “ BTS Resource Depletion ” \}} \qquad ( Eqn . 3 )$$

Also, for example, a GC rule may be created to recycle transient network device instances. Otherwise, the accumulated transient network device instances may continue to reside in memory, and this may cause a program to repeatedly generate false alarms. Accordingly, the GC rule releases a transient network device when its timer expires. For example, when the timer associated with the transient network device expires, the following GC rule can be triggered to remove the transient network device and decrease the transient network device counter:

$$\frac{( ∃ t\_ue ( u ) ∈ S ) ∧ ( t - {u}_{t} > {T}_{release} ) ∧ ( ∃ cnt ( c ) ∈ S ) ∧ ( {c}_{bs} = {u}_{bs} )}{{S}^{′} = S - \{ u \} - \{ c \} ⋃ \{ cnt \vert {c}_{bs} , {c}_{value} - 1 \}} \qquad ( Eqn . 4 )$$

### Detecting Blind DoS Attacks

In contrast to BTS resource depletion attacks, the blind DoS attack (e.g., second row of column 11C1 of FIG. 11) pinpoints a network device by establishing an RRC connection using an S-TMSI in LTE or 5G networks. The S-TMSI can be harvested via silent paging attacks or packet sniffing. Based on 3GPP TS 38.331, the BS generally deletes a RRC security context and releases the connection for a target network device, thus triggering a DoS scenario. Therefore, an example rule to detect blind DoS attacks may be based on S-TMSI replay with the following rule:

$$\frac{\begin{matrix}( ∃ ue ( {u}_{1} ) ∈ S ) ∧ ( ∃ ue ( {u}_{2} ) ∈ S ) ∧ ( {u}_{{1}_{bs}} = {u}_{{2}_{bs}} ) ∧ \\ ( {u}_{{1}_{rrc \_ state}} = {u}_{{2}_{rrc \_ state}} = 2 ) ∧ ( {u}_{{1}_{tmsi}} = {u}_{{2}_{tmsi}} ) ∧ ( {u}_{{1}_{t}} < {u}_{{2}_{t}} )\end{matrix}}{{S}^{′} = S ⋃ \{ event \vert {u}_{{2}_{bs}} , {u}_{{2}_{rnti}} , t , “ Blind DoS ” \}} \qquad ( Eqn . 5 )$$

The rule in Eqn. 5 determines whether a malicious network device (u2) initiates an RRC connection by replaying the S-TMSI of another actively connected network device (u1) in the same network. Such a rule ensures that the S-TMSI of the two network devices are equal and distinguishes the attacker and the victim based on the RRC timers (i.e., the attack establishes the RRC connection with the attacker device after the connection with the victim device).

### Level of Alerts

The example rule sets described herein effectively detect malicious attacks while not producing a large number of false alarms. However, distinguishing attacks from benign traffic is a challenging task in cellular networks (e.g., FBS detection and intrusion detection). Accordingly, different alert levels may be configured different attacks.

Referring again to FIG. 11, column 11C6 indicates an alert level. For instance, employing null cipher or integrity protection may be caused by a MiTM attacker that injects a failure control message in the traffic that is consistent with the network specifications. As a result, for an event that cannot be identified as an attack with a high confidence level, that event may be reported as a warning instead of being flagged as a malicious attack.

### Evaluations

To evaluate an example prototype, an O-RAN testbed may be configured for 5G-SPECTOR. For example, the testbed may involve a host machine (e.g., Ubuntu 18.04 OS) equipped with six INTEL® i7-8700 cores and 32 GB RAM, that runs three virtual machines (VMs) for the core network, RIC, and RAN (i.e., CU and DU), respectively. The RU front-end may be an OAI nFAPI emulator or a physical Universal Software Radio Peripheral (USRP) B210 SDR attached to the RAN machine via USB 3.0.

To determine whether 5G-SPECTOR is capable of detecting known and unknown cellular L3 attacks, an evaluation may be performed against two sets of simulated attacks, including the seven known attacks described in table 1100 of FIGS. 11, and 11 unknown attacks derived as variants from the seven known attacks.

To evaluate a scalability of 5G-SPECTOR to real-world cellular networks, an evaluation may be performed against benign and abnormal cellular network traffic from public datasets. To determine whether 5G-SPECTOR may be deployed effectively to detect L3 cellular attacks in practice, an evaluation may be performed with two L3 attacks fully replicated over-the-air using COTS SDRs and smartphones. To evaluate a performance of 5G-SPECTOR, parameters such as throughput and detection latency may be analyzed. To determine an amount of overhead that 5G-SPECTOR introduces to the original network, the overhead imposed on the O-RAN data plane and the control plane may be measured, including CPU and memory consumption.

### Evaluation with Simulated Attacks and Variants

Additional evaluations may be performed to determine whether 5G-SPECTOR has an appropriate feature set and programming capability to detect known and unknown L3 attacks. For example, two sets of cellular L3 attacks may be emulated. The first set involves the seven attacks (described in table 1100), which represent seven known attacks. The second set involves eleven unknown attacks that may be derived as variants from the known attack set. The attack simulation may be implemented based on an OAI nFAPI emulator that enables the physical layer communication between the network device and the RU to be emulated.

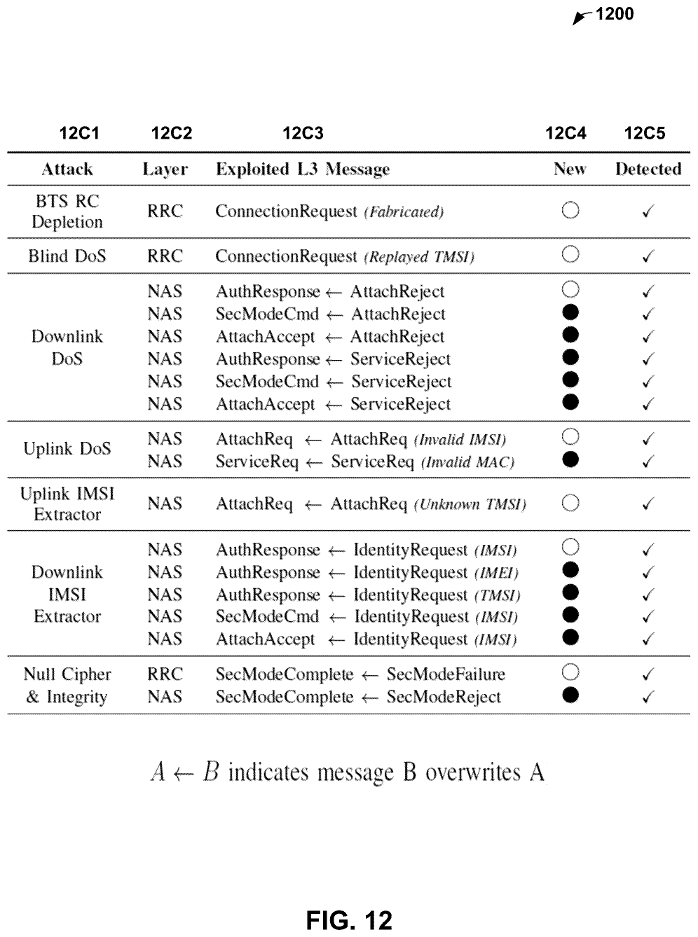

FIG. 12 illustrates a table 1200 with results of an evaluation of known and unknown attacks, in accordance with example embodiments. Column 12C1 lists the seven attacks listen in column 11C1 of table 1100. Column 12C2 indicates the associated layer (e.g., NAS or RRC). Column 12C3 indicates the associated L3 message that can be exploited. Generally, “A←B” indicates that message B overrides message A. For example, “AuthResponse←AttachReject” indicates that the message “AttachReject” overrides the message “AuthResponse.”

Column 12C4 indicates whether the type of attacks is known or new. For example, the seven known attacks are associated with empty circles, and the eleven variants based on the seven known attacks are associated with filled-in circles. Column 12C5 indicates that 5G-SPECTOR is able to detect the seven known and eleven unknown attacks.

The seven known attacks may be emulated based on their descriptions. For example, malicious code logic may be inserted into the RRC and NAS tasks in the OAI implementation. Such an implementation launches a rogue network device that repeatedly creates RRC connections in a simulated network to ultimately DoS other legitimate network devices. As described with reference to FIG. 11, corresponding detection signature sets may be implemented for the seven attacks. The eleven variants that are created from the seven known attacks, are considered unknown to 5G-SPECTOR. For evaluation purposes, two mutation strategies may be used. For example, based on the attack description of the seven known attacks and the attack session, a first mutation strategy may be to replace an exploited message with an equivalent one that triggers the same consequence (e.g., AttachReject may be replaced by ServiceReject to achieve the same DoS effect). A second mutation strategy may be to move the exploited message to other RRC or NAS phases of the session (e.g., IdentityRequest injection may occur during authentication or security mode procedures to expose the victim's IMSI in plain text).

Based on these example strategies, 18 attacks may be created, including the seven known attacks and the eleven unknown attacks. To extend 5G-SPECTOR for the eleven unknown attacks, an additional 90 lines of code may be developed in P-BEST, based on the original 758 lines of code programmed for the known attacks. Accordingly, the evaluation indicates that 5G-SPECTOR is extensible to unknown attacks with the feature sets and programming capability. Also, for example, the example prototype may be evaluated against the 18 attacks, and each attack instance may be tested 20 times. As indicated in FIG. 12, 5G-SPECTOR is capable of effectively detecting all eighteen attacks by generating accurate and reproducible alerts in real-time, indicating a zero false negative rate among these samples. The evaluation results also indicate that 5G-SPECTOR can be programmed and extended with effective IDS rule sets that can detect existing and potential (unknown) L3 cellular attacks.

### Evaluation With Real-World Datasets

To evaluate a scalability of 5G-SPECTOR to practical cellular networks, without generating a high number of false alarms, an evaluation may involve datasets with traces collected from real-world network devices.

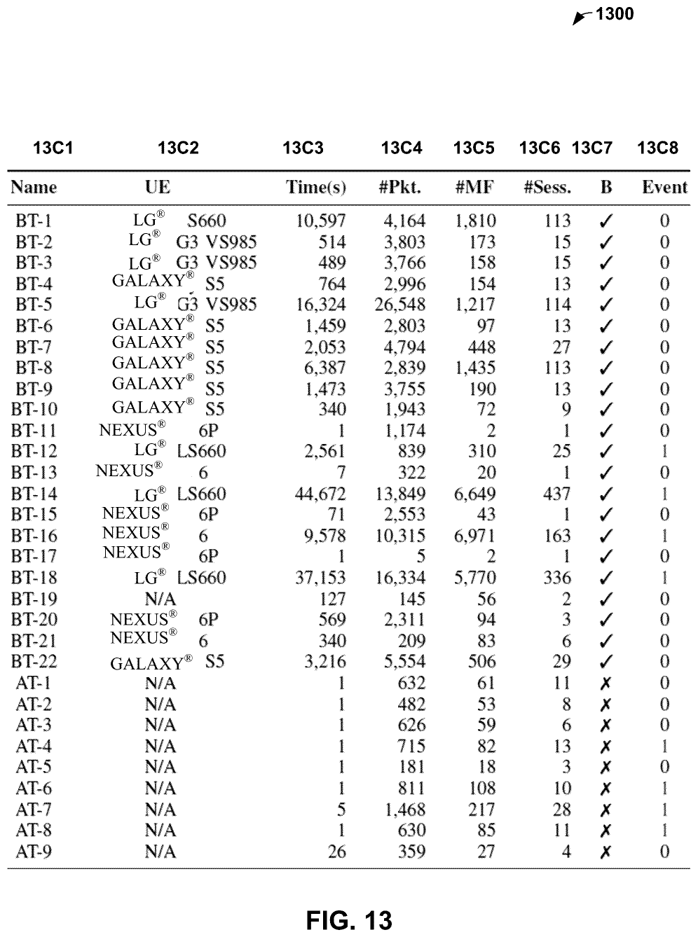

FIG. 13 illustrates a table 1300 with results of an evaluation using real-world cellular traffic, in accordance with example embodiments. As indicated in column 13C1, there are 22 benign traces (BT-1 to BT-22) collected from different COTS network devices and network operators, and 9 abnormal network device traces (AT-1 to AT-9) created by academic researchers. Each trace spans varied time (from several seconds to a few hours) and involves many network device sessions with the network. In one aspect, non-L3 packets (e.g., cell measurement packets) may be filtered out. Also, for example, 118, 145 raw packets (e.g., in pcap format) may be converted into 26,790 MobiFlow records, based on the definition for MobiFlow described with respect to FIG. 8. In some instances, the network traffic data may be collected from LTE networks; however, the results remain applicable to 5G and other higher generation networks due to a consistency of the RRC and NAS protocols.

MobiFlow records may be generated and provided to 5G-SPECTOR, and table 1300 displays the results, including a number of events reported for each trace. Column C2 lists a type of network device, column 13C3 indicates a number of times. Column 13C4 indicates the number of packets. Column 13C5 indicates the number of associated MobiFlow records, and column 13C6 indicates a number of sessions. Column 13C7 indicates whether the event is benign or not, as indicated by a check and a cross, respectively.

As shown in column 13C8, the xApp, MobiExpert, generated 8 warning events (e.g., indicated by a numeral “1”) based on the alert levels described previously, and no attack events were reported. The evaluation also indicates that the detection rules function correctly, and that the root cause for a successful attack is that the network devices associated with these traces employ insecure null cipher or integrity algorithms in practice. For instance, in BT-14, the network device uses EEA0 and EIA1 algorithms for encryption and integrity protection, respectively, which were likely limited by the network device or network's capability. Based on the rules and alert levels described previously, MobiExpert does not label them as attacks, and reports them as insecure practices, as such activities may not always constitute attacks but may result in security and privacy related vulnerabilities for a network device. Generally, the example implementation of 5G-SPECTOR described herein appears to produce alerts at a relatively low frequency (i.e., one warning per 374 network device sessions on average), and does not generate false alarms among the traces that were validated.

### Evaluation With Over-the-Air Attacks

To demonstrate that 5G-SPECTOR may be deployed to address L3 attacks in practice, an evaluation may be performed against two over-the-air (OTA) attacks reproduced using the testbed described herein, namely the BTS resource depletion attack and the blind DoS attack. Note that OTA reproduction may involve a relatively more sophisticated setup than a simulation since the physical layer signals are to be properly setup in addition to the attack code implementation.

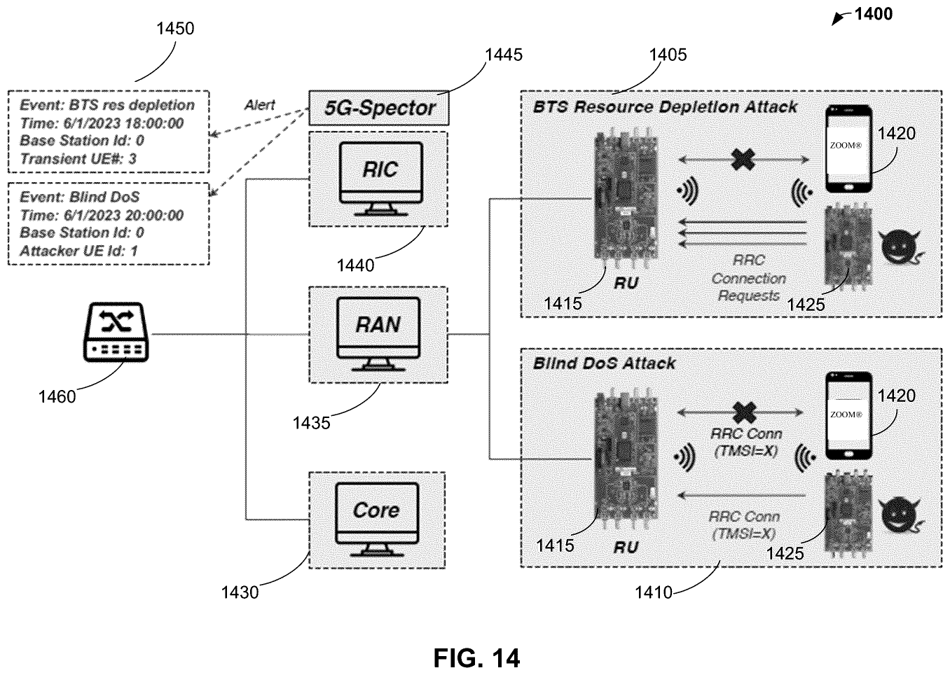

FIG. 14 illustrates an example over-the-air (OTA) attack setup 1400, in accordance with example embodiments. A BTS resource depletion attack 1405 and a Blind DoS attack 1410 are illustrated. In each instance, a communication between a RU 1415 and a target network device 1420 may be compromised by a rogue agent 1425.

As illustrated, a USRP B210 may be an RF front-end of rogue agent 1425 that attaches to a RAN VM 1435 via USB 3.0. Target network device 1420 may be a COTS PIXELR® 5 and rogue agent 1425 may be USRP B210. To demonstrate the attack effect (e.g., a connection of the network device is dropped), the PIXELR 5 may be configured to open an active Zoom session as it connects to the data network 1460 through the EPC.

The OTA reproduction may be performed similarly to the example emulation described previously, by inserting malicious logic to the OAI network device code running on the attacker USRP represented by rogue agent 1425. Additionally, the network device's physical layer code may be modified as needed. For instance, the BTS resource depletion attack 1405 involves resetting the physical layer parameters when an RRC connection is restarted. At layer 3, the malicious network device (e.g., rogue agent 1425) may be controlled to restart after AuthRequest and continuously create fabricated RRC connections, in order to reproduce the BTS resource depletion attack 1405.

For the blind DoS attack 1410, the victim network device (e.g., target network device 1420) may be connected, and a TMSI associated with the victim network device may be extracted from the EPC's log. Subsequently, the TMSI may be passed to the attacker (e.g., rogue agent 1425) to simulate an assumption that the attacker knows the TMSI, and the attacker may be commanded to initiate an RRC connection with the TMSI. Upon launching these two attacks, the Zoom session associated with the victim network device (e.g., target network device 1420) appeared to be frozen as the connection was released by the BS (e.g., RU 1415) because of the exhaustion of BTS resources, and/or the duplicated network device sessions. As illustrated, data associated with RAN 1435 may be collected, and RIC 1440 may generate a telemetry stream and provide it to the application layer xApp, 5G-SPECTOR 1445. The telemetry stream may be analyzed and, 5G-SPECTOR may generate alerts 1450 with the attack details. Repeated experiments indicate that the detection results of 5G-SPECTOR are reproducible and do not include false negatives.

### Performance Evaluations

### Throughput

A throughput associated with 5G-SPECTOR may be evaluated. The throughput generally indicates how many MobiFlow packets may be generated per unit of time. Ideally, assuming that the RIC receives network packets at max bandwidth, the throughput depends on various parameters and may be determined as:

$$T ∝ \frac{{T}_{ric} \cdot v}{gp \cdot {size}_{mf}} \qquad ( Eqn . 6 )$$

where the throughput, T, is proportional to the RIC machine's throughput (Tric) and its speed for generating MobiFlow packets (v). The throughput is inversely proportional to the granularity period (gp) and a size of each MobiFlow packet (size_mf). In an example implementation, each MobiFlow packet may be 406 bytes and the bandwidth between the RAN and RIC machine may be 220 MB/s.

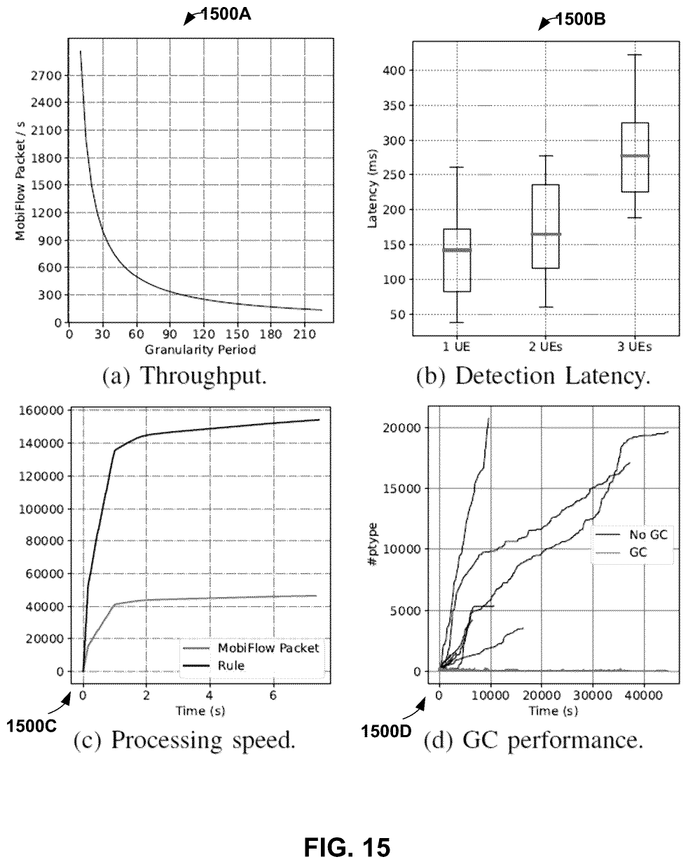

FIG. 15 displays graphical illustrations of performance evaluations, in accordance with example embodiments. Graph 1500A illustrates a maximum throughput with respect to a granularity period on an RIC machine. The vertical axis represents a number of MobiFlow records per second, and the horizontal axis represents a granularity period. As illustrated, the maximum throughput decreases as the granularity period is increased.

### Detection Latency

Detection latency generally measures a delay for a network device control packet at the RAN to be converted into MobiFlow at the MobiExpert xApp. Detection latency, L, is proportional to the granularity period (gp) and the number of network devices attached (n_ue), and inversely proportional to several parameters, including the speed of the network v_network, speed of the RF v_rf, and speed of the data processing v_process (e.g., MobiFlow generation in the SecSM agents), and may be determined as:

$$L ∝ \frac{gp \cdot {n}_{ue}}{{v}_{network} \cdot {v}_{process} \cdot {v}_{rf}} \qquad ( Eqn . 7 )$$

In some example evaluations, the latency may be measured with respect to the number of network devices attached to the network simultaneously, with a granularity period set to be 200 ms. An emulation setup may be used to generate multiple network device connections, and this removes RF latency between a network device and RAN from consideration. Due to the limitation of the nFAPI emulator, at most three network devices were emulated.

Referring again to FIG. 15, graph 1500B illustrates detection latency for an emulation using one network device, two network devices, and three network devices. The vertical axis represents the latency in milliseconds (ms), and the horizontal axis a number of network devices. As illustrated, the average latency is 140 ms, 160 ms, and 280 ms under the three settings, respectively. As illustrated, an average latency increases as a number of network devices increases.

### Efficiency

Efficiency may be evaluated by analyzing a number of MobiFlow packets that may be simultaneously processed by the MobiExpert xApp. Referring again to FIG. 15, graph 1500C illustrates processing speed. The vertical axis represents a number of MobiFlow packets processed, and the horizontal axis represents time in seconds. For example, a stress test may be performed by inserting approximately 50,000 MobiFlow records, and MobiExpert appears to have efficiently processed over 40,000 or 80% of the records, and executed nearly 140,000 rules within one second. However, the processing speed appears to decrease thereafter. This is likely due to a large number of ptype creations that constantly call malloc( ), and GC was likely unable to trigger within this short period of time.

### GC Performance

Performance of the GC system may be evaluated by testing each cellular trace with and without GC and plotting a number of ptypes in real-time. Referring again to FIG. 15, graph 1500D illustrates GC performance. The vertical axis represents a number of ptypes, and the horizontal axis represents time in seconds. As illustrated, GC appears to significantly reduce memory consumption by releasing unused ptypes at run-time. By deploying GC rules, the number of ptypes may be maintained below a few hundred among traces tested over time. In contrast, the number of ptypes without GC appears to be significantly higher (e.g., 200× in a worst case scenario).

### Evaluation of Overhead

An impact of 5G-SPECTOR on the control plane and the data plane may be evaluated. For example, a CPU and memory overhead on the RIC and RAN machines may be measured with respect to a number of attached network device. The evaluation may be performed with up to three network devices due to the tool limitation and resource constraints.

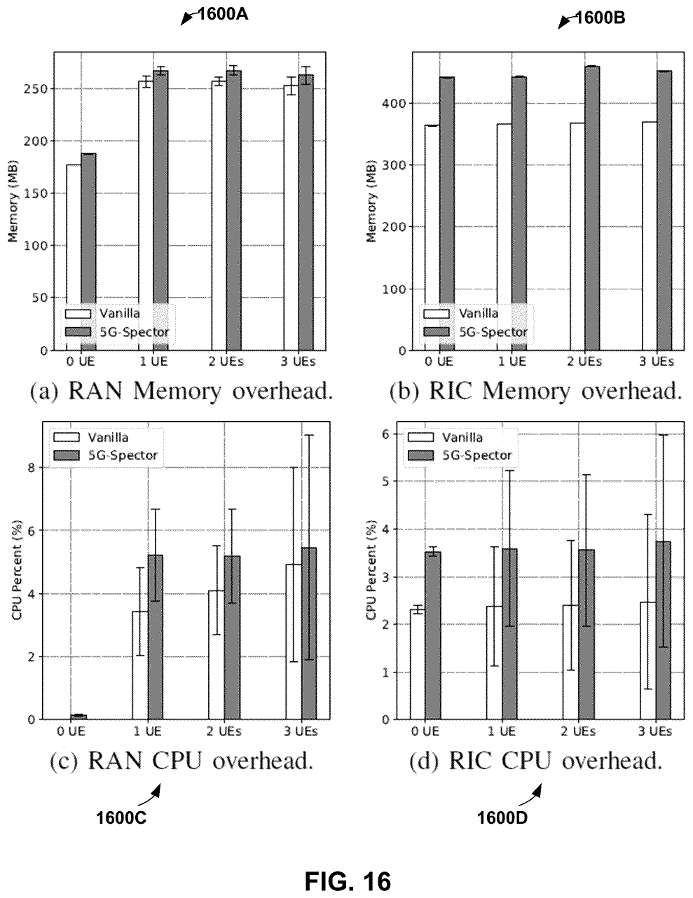

FIG. 16 displays graphical illustrations of overhead evaluations, in accordance with example embodiments. Graph 1600A illustrates RAN memory overhead, graph 1600B illustrates RIC memory overhead, graph 1600C illustrates RAN CPU overhead, and graph 1600D illustrates RIC CPU overhead.

The example implementation appears to introduce an average 10 MB and 80 MB memory overhead to the RAN and the RIC, respectively, which is 4% and 20% of the total memory consumption. The memory overhead on the RIC appears to be higher likely due to the MobiExpert xApp. The CPU overhead varies on the two planes. For the data plane, the CPU overhead appears to decrease as the RAN runs more network devices (from 1.8% to 0.5%). This is likely because a cost of a vanilla CPU increases faster. For the control plane, the CPU overhead appears to be around 1.4% on average across the network device numbers. The error bars represent fluctuations due to the network device attachment procedure with apparent impact on the CPUs.

### Additional Considerations

The detection rules associated with 5G-SPECTOR are based on abnormal states and transmissions of unprotected L3 messages. In practice, such anomalies may occur due to external noise (e.g., bit error) and thus may introduce false positives. Additionally, some signatures may indicate abnormal activities that may not correspond to attacks. For example, it may be compliant for two network devices to use the same TMSI to attach to a network, as the RRCConnectionRequest may be sent from an attacker or a legitimate user. This could represent, for example, a blind DoS attack or an abnormal network condition. However, evaluations with repeated attack simulation, and based on a large number of real-world cellular traces, appear to indicate that 5G-SPECTOR does not produce false positives, indicating that such scenarios are likely rare in practice.

As described, the components that are designed and developed (e.g., MobiFlow, SecSM, and MobiExpert) comply with the O-RAN specifications, and are scalable to real O-RAN compliant networks.

Accordingly, an O-RAN compliant L3 attack detection service is described, that may be deployed at the O-RAN control plane and provides it with programmability to facilitate various security applications. A P-BEST language-based xApp (e.g., MobiExpert) may be configured to run on top of a telemetry stream (e.g., MobiFlow) generated by a security service component (e.g., SecSM) at the control layer. A prototype of 5G-SPECTOR may be described, and tested with seven known L3 attacks, and 31 cellular network traces in practice. 5G-SPECTOR appears to be able to effectively detect existing and unknown attacks, and can be scalable to real-world scenarios. A comprehensive evaluation of the IDS illustrates that the system can operate at a high speed with low latency while introducing low overhead to the original RAN.

### Example Network Environment

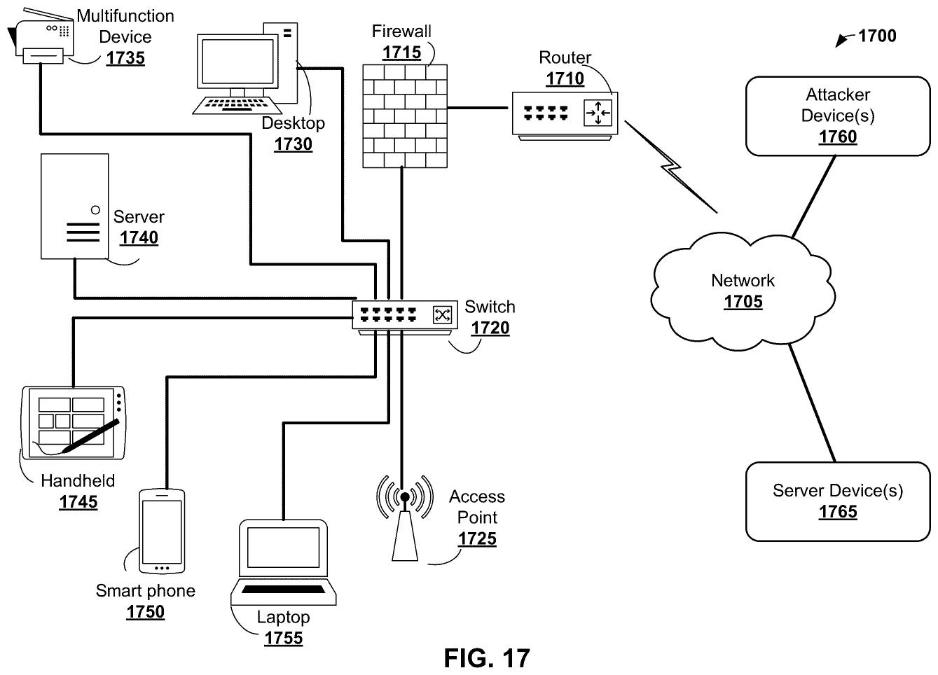

FIG. 17 depicts a network environment 1700, in accordance with example embodiments. Network environment 1700 includes network 1705, attacker device(s) 1760, and server device(s) 1765, that are configured to communicate, via network 1705, with one or more devices such as a desktop 1730, a device 1735, a server 1740, a handheld device 1745, a smart phone 1750, and/or a laptop 1755.

Network 1705 may correspond to a local area network (LAN), a wide area network (WAN), a WLAN, a WWAN, a corporate intranet, the public Internet, or any other type of network configured to provide a communications path between networked computing devices. Network 1705 may also correspond to a combination of one or more LANs, WANs, corporate intranets, and/or the public Internet.

The network environment 1700 may include tens, hundreds, or thousands of devices. In some examples, the one or more devices can be directly connected to network 1705. In other examples, the devices can be indirectly connected to network 1705 via router 1710, firewall 1715, network switch 1720, and/or access point 1725. In this example, router 1710, firewall 1715, network switch 1720, and/or access point 1725 can act as an associated computing device to pass electronic communications between the one or more devices and network 1705. Although an example physical topology of network 1705 is illustrated in FIG. 17, it is understood that network 1705 may be associated with a logical topology for data flow between physical components of network 1705.

Router 1710 can be configured to transmit packets by processing routing information included in a packet (e.g., Internet protocol (IP) data from layer 3). The routing information can be processed via a routing table. Firewall 1715 is a network device that can be configured to control network security and access rules. Network switch 1720 can be a single switch or an array of switches. Switch 520 is a network device that can be configured to connect various devices on a network, such as, for example, desktop 1730, device 1735, server 1740, handheld device 1745, smart phone 1750, and/or laptop 1755. Switch 520 can use packet switching to receive and forward data between devices in a network. Access point 1725 is a network device that can be configured to provide wireless access to various devices on the network.

Server devices 1765 can be configured to perform one or more services, as requested by the one or more devices. For example, server device 1765 can provide content to the one or more devices. The content can include, but is not limited to, content available over the World Wide Web (WWW), content from a dedicated server, software, images, audio, and/or video. The content can include confidential information. Although server 1740 is shown as a single server, it can represent a plurality of servers, and/or a data center comprising a plurality of servers.

In some embodiments, attacker device 1760 can be a device that performs penetration and intrusion acts that target wireless networks in one or more devices (e.g., network provided by access point 1725) to capture and/or intercept information exchanged over the network and/or intrude with the traffic of information.

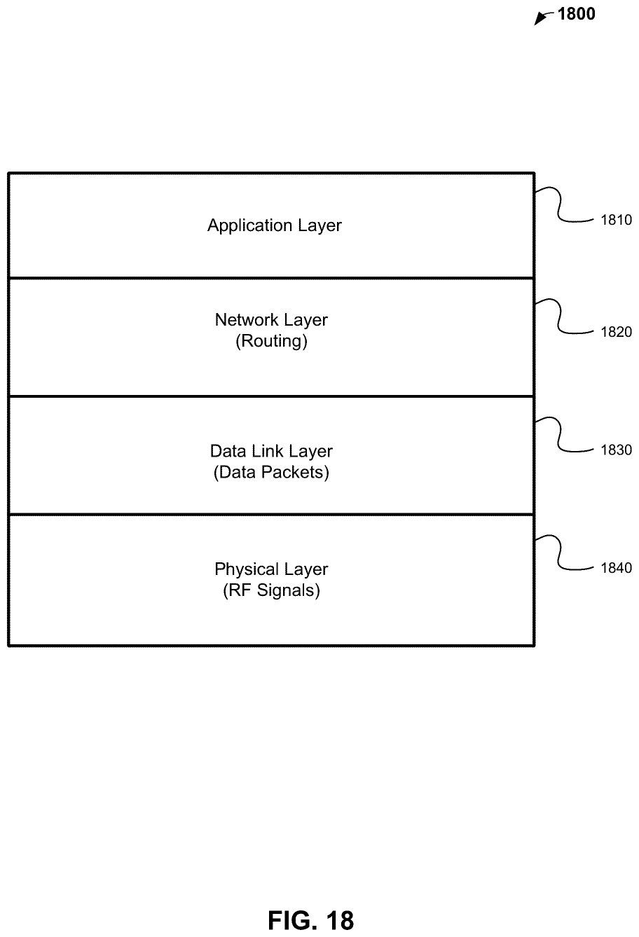

FIG. 18 depicts a protocol stack 1800, in accordance with example embodiments. The protocol stack 1800 enables nodes in a packet-switched network (e.g., network environment 1700) to communicate with one another. The term “node” can refer to any computing device in a network, including wireless access points, wireless devices, etc. Protocols that implement a packet-switched network divide messages into packets before the messages are sent. Each packet contains the source and destination addresses and the data. Each packet is then transmitted individually and can follow different routes to its destination. The original message is recompiled at the destination after all the packets forming the message arrive.

Network communication among the nodes (and wireless access points) is generally conceptualized in terms of protocol layers, such as the physical layer 1840, data link layer 1830, network layer 1820, and application layers 1810, and such protocol layers form a protocol stack 1800. In general, the protocol layers exchange control and status information with one another. For a node transmitting a communication, control starts at the application layer 1810 and passes layer by layer to the physical layer 1840, which sends the communication over a communication link to a receiving node. The receiving node processes the communication, layer by layer, up the stack of protocol layers, starting at the physical layer 1840 and ending at the application layer 1810. It is to be understood that the protocol stack 1800 can have additional protocol layers to those shown, such as a transport layer. The protocol used at the physical layer 1840 of the protocol stack 1800 accommodates the type of physical medium over which the nodes communicate. The physical layer 1840 conveys the bit stream in the radio signal through the network environment 1700 at the electrical and mechanical level, and provides the hardware means of sending and receiving data.

In one embodiment, the nodes in network environment 1700 communicate with each other over links using an IEEE 802.11 wireless communications standard (e.g., IEEE 802.11(a), IEEE 802.11(b), and IEEE 802.11(g)). Other embodiments of wireless communications standards that can be used by the nodes include BLUETOOTH, HYPERLAN, and HomeRF. For a node operating according to the IEEE 802.11, the physical layer 1840 specifies the physical aspects of the radio signaling (e.g., frequency hopping spread spectrum (FHSS), and direct sequence spread spectrum (DSSS)).

The data link layer 1830 encodes and decodes data packets into bits and handles errors in the physical layer 1840, flow control and frame synchronization. In one embodiment, the data link layer 1830 comprises two sub-layers: a Logical Link Control (LLC) layer and a Media Access Control (MAC) layer (the lower of the two sub-layers). The MAC sub-layer controls access to the physical transmission medium; the LLC layer controls frame synchronization, flow control, and error checking. The network (or routing) layer 1820 provides a protocol for forwarding and routing packets through the network environment 1700, by creating logical paths for transmitting packets from node to node.

### Example Computing Device

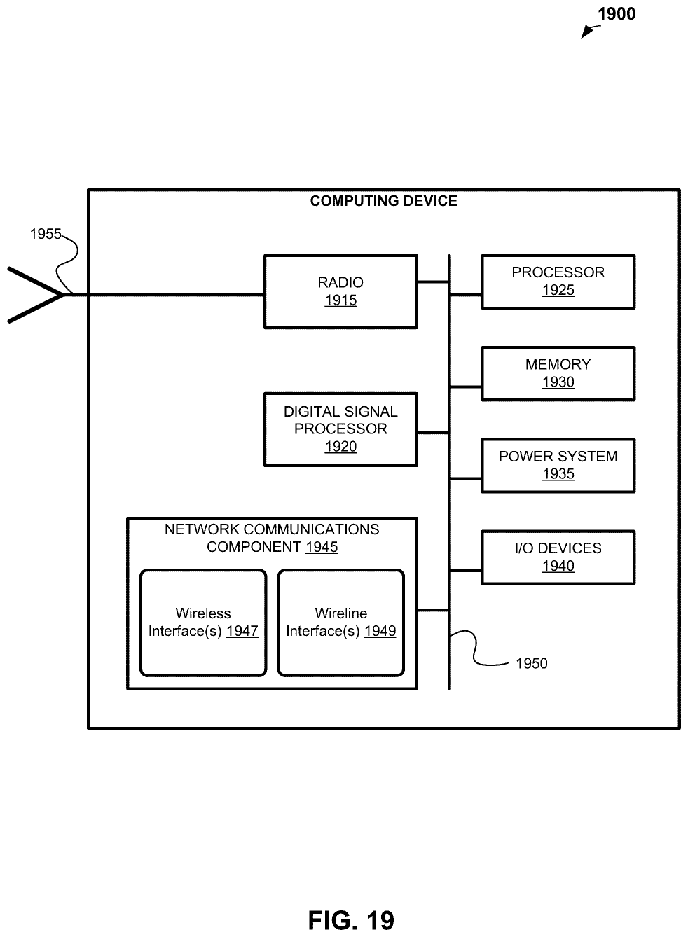

FIG. 19 is a block diagram of an example computing device 1900, in accordance with example embodiments. Computing device 1900 can include a radio 1915, a digital signal processor 1920, one or more processors 1925, memory 1930, power system 1935, input/output devices 1940, and network communications component 1945, all of which may be linked together via a system bus, network, or other connection mechanism 1950, and an antenna 1955 to communicate with a wireless access point. Computing device 1900 can be one or more of the devices described with reference to FIG. 17 (e.g., desktop 1730, a device 1735, a server 1740, a handheld device 1745, a smart phone 1750, and/or a laptop 1755).

Radio 1915 may be a single physical layer (L1) interface that enables access to wireless media. A software driver can implement Media Access Control (MAC) functionality at layer-2 (L2) of an Open System Interconnect (OSI) standard to instantiate multiple simultaneous virtual network interfaces. Radio 1915 may be coupled to antenna 1955. A Digital Signal Processor (DSP) 1920 may be coupled to the radio 1915 and a Central Processing Unit (e.g., processor 1925). A media access controller (MAC) may be a separate chip or may be integrated into processor 1925.

One or more processors 1925 can include one or more general purpose processors, and/or one or more special purpose processors (e.g., digital signal processors, graphics processing units (GPUs), application specific integrated circuits, etc.). One or more processors 1925 can be configured to execute computer-readable instructions that are contained in memory 1930 and/or other instructions as described herein.

Memory 1930 can include one or more non-transitory computer-readable storage media that can be read and/or accessed by at least one of one or more processors 1925. The one or more computer-readable storage media can include volatile and/or non-volatile storage components, such as optical, magnetic, organic or other memory or disc storage, which can be integrated in whole or in part with at least one of one or more processors 1925. In some examples, memory 1930 can be implemented using a single physical device (e.g., one optical, magnetic, organic or other memory or disc storage unit), while in other examples, memory 1930 can be implemented using two or more physical devices.

Power system 1935 can include one or more batteries and/or one or more external power interfaces for providing electrical power to computing device 1900. One or more external power interfaces of power system 1935 can include one or more wired-power interfaces, such as a USB cable and/or a power cord, that enable wired electrical power connections to one or more power supplies that are external to computing device 1900.

Input/output devices 1940 may include storage devices, a receiver, a transmitter, a speaker, a display, an image capturing component, an audio recording component, a user input device (e.g., a keyboard, a mouse, a microphone), and so forth. Although not shown in FIG. 19, one or more of I/O devices 1940 may be a device external to computing device 1900. Such an external device may communicate with computing device 1900 via a wired or wireless connection, and such communication may be facilitated by an I/O interface of computing device 1900.

Network communications component 1945 can include one or more devices that provide one or more wireless interfaces 1947 and/or one or more wireline interfaces 1949 that are configurable to communicate via a network. Wireless interface(s) 1947 can include one or more wireless transmitters, receivers, and/or transceivers, such as a Bluetooth™ transceiver, a Wi-Fi™ transceiver, an LTE™ transceiver, and/or other type of wireless transceiver configurable to communicate via a wireless network. Wireline interface(s) 1949 can include one or more wireline transmitters, receivers, and/or transceivers, such as an Ethernet transceiver, a Universal Serial Bus (USB) transceiver, or similar transceiver configurable to communicate via a physical connection to a wireline network.

Network communications component 1945 can be configured to provide reliable, secured, and/or authenticated communications between various components. For each communication described herein, information for facilitating reliable communications (e.g., guaranteed message delivery) can be provided, perhaps as part of a message header and/or footer (e.g., packet/message sequencing information, encapsulation headers and/or footers, size/time information, and transmission verification information). Communications can be made secure (e.g., be encoded or encrypted) and/or decrypted/decoded using one or more cryptographic protocols and/or algorithms, such as, but not limited to, a secure sockets protocol such as Secure Sockets Layer (SSL), and/or Transport Layer Security (TLS).

### Example Methods of Operation

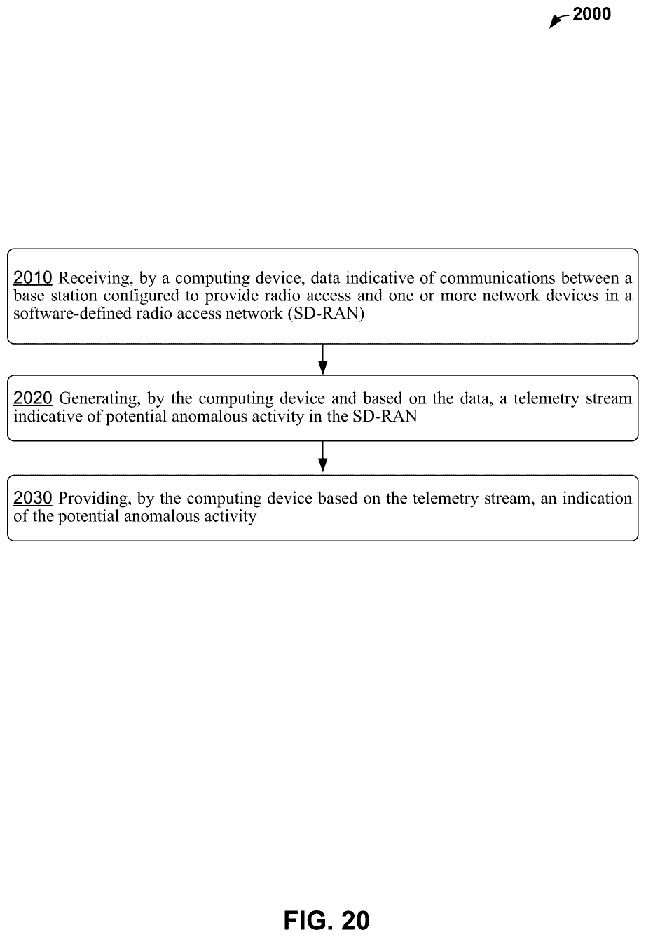

FIG. 20 illustrates an example method 2000, in accordance with example embodiments. Method 2000 may include various blocks or steps. The blocks or steps may be carried out individually or in combination. The blocks or steps may be carried out in any order and/or in series or in parallel. Further, blocks or steps may be omitted or added to method 2000.

The blocks of method 2000 may be carried out by various elements of computing device 1900 as illustrated and described in reference to FIG. 19.

Block 2010 includes receiving, by a computing device, data indicative of communications between a base station configured to provide radio access and one or more network devices in a software-defined radio access network (SD-RAN).

Block 2020 includes generating, by the computing device and based on the data, a telemetry stream indicative of potential anomalous activity in the SD-RAN.

Block 2030 includes providing, by the computing device and based on the telemetry stream, an indication of the potential anomalous activity.

In some embodiments, the potential anomalous activity may include one or more of an attack on the base station, a fault in the RAN, a failure of the RAN, a security threat, a noncompliance by one or more network devices, or a violation of a service level agreement (SLA).

In some embodiments, the telemetry stream may be configured to reduce one or more of a network packet delay or a packet drop rate.

In some embodiments, the receiving of the data involves aggregating, for a given network device of the one or more network devices, the one or more network packets associated with the given network device into an indication message. Such embodiments also involve detecting a triggering event associated with the given network device. Such embodiments additionally involve responsive to the detecting of the triggering event, sending the indication message. In some embodiments, the triggering event may be a new state for the given network device or a control traffic for the given network device. In some embodiments, the indication message may be indicative of a session establishment or a device authentication.

In some embodiments, the receiving of the data involves receiving one or more network packets associated with the given network device during a granularity period. Such embodiments also involve storing the one or more network packets in a buffer associated with the given network device prior to the sending of the indication message.

In some embodiments, the generating of the telemetry stream may be performed by a security service component. The security service component may be compliant with one or more policies of the RAN.

In some embodiments, the telemetry stream may be a network device-centric telemetry stream. Such embodiments involve tracking a temporary identifier associated with a given network device of the one or more network devices, wherein the temporary identifier enables an identification of a unique session establishment between the given network device and the RAN.

In some embodiments, the telemetry stream may be a network device-centric telemetry stream. Such embodiments involve tracking a temporary identifier associated with a given network device of the one or more network devices, wherein the temporary identifier enables an identification of a unique device authentication between the given network device and the RAN.

In some embodiments, the telemetry stream may be a network device-centric telemetry stream. Such embodiments involve tracking a permanent identifier associated with a given network device of the one or more network devices, wherein the permanent identifier comprises one or more of an International Mobile Equipment Identity (IMEI), an International Mobile Subscriber Identity (IMSI), or a Subscription Concealed Identifier (SUCI).

In some embodiments, the telemetry stream may be a RAN-centric telemetry stream. Such embodiments involve tracking aggregated statistics of one or more states associated with the RAN. In some embodiments, the one or more states may include one or more of a number of connected network devices, a number of idle network devices, or a maximum capacity associated with the RAN.

In some embodiments, the providing of the indication of the potential anomalous activity may be performed by an application layer of the software-defined radio access network. In some embodiments, the application layer may be configured based on a Production-Based Expert System Toolset (P-BEST) language.

In some embodiments, a central unit (CU) may include a CU-control (CU-C) and a CU-user (CU-U). The receiving of the data involve receiving session establishment data from the CU-C, and receiving device performance data from the CU-U. The providing of the indication of the potential anomalous activity may be based on a correlation of the session establishment data and the device performance data.

In some embodiments, the SD-RAN may be an open radio access network (O-RAN).

In some embodiments, the O-RAN may include at least one logical node, and the receiving of the data involves collecting, by a software agent deployed on the at least one logical node, respective RAN-related telemetry or network device-related telemetry.

In some embodiments, the at least one logical node includes a Radio Unit (RU), a Distributed Unit (DU), or a Central Unit (CU).

In some embodiments, the SD-RAN is a higher generation cellular network.

In some embodiments, the computing device may include a first computing device in a network layer of the SD-RAN. The receiving of the data may be performed by the first computing device. The first computing device may be configured to operate in parallel with one or more logical nodes that manage protocols for the SD-RAN.

In some embodiments, the computing device may include a second computing device in a control layer of the SD-RAN. The generating of the telemetry stream may be performed by the second computing device. The second computing device may be configured to run in a RAN intelligent controller (RIC).

In some embodiments, the computing device may include a third computing device in an application layer of the SD-RAN. The providing of the indication may be performed by the third computing device.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information and/or comparison of signals can correspond to circuitry that can be configured to perform the specific logical functions of a herein-described method or technique. Alternatively or additionally, a step or block that represents a processing of information and/or comparison of signals can correspond to a component, a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

Note, an application described herein includes but is not limited to software applications, mobile applications, and programs that are part of an operating system application. Some portions of this description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms can be written in a number of different software programming languages such as C, C++, HTTP, Java, or other similar languages. Also, an algorithm can be implemented with lines of code in software, configured logic gates in hardware, or a combination of both. In an embodiment, the logic consists of electronic circuits that follow the rules of Boolean Logic, software that contain patterns of instructions, or any combination of both. A component may be implemented in hardware electronic components, software components, and a combination of both.

Generally, application includes programs, routines, objects, widgets, plug-ins, and other similar structures that perform particular tasks or implement particular abstract data types. Those skilled in the art can implement the description and/or figures herein as computer-executable instructions, which can be embodied on any form of computing machine-readable media discussed herein.

Many functions performed by electronic hardware components can be duplicated by software emulation. Thus, a software program written to accomplish those same functions can emulate the functionality of the hardware components in input-output circuitry.

While various examples and embodiments have been disclosed, other examples and embodiments will be apparent to those skilled in the art. The various disclosed examples and embodiments are for purposes of illustration and are not intended to be limiting, with the true scope being indicated by the following claims.

What is claimed is:

1. A computer-implemented method for monitoring a software-defined radio access network (SD-RAN), comprising:
receiving, by a computing device, data indicative of communications between a base station configured to provide radio access and one or more network devices;
generating, by the computing device and based on the data, a telemetry stream indicative of potential anomalous activity in the SD-RAN; and
providing, by the computing device and based on the telemetry stream, an indication of the potential anomalous activity.

2. The computer-implemented method of claim 1, wherein the potential anomalous activity comprises one or more of an attack on the base station, a fault in the RAN, a failure of the RAN, a security threat, a noncompliance by one or more network devices, or a violation of a service level agreement (SLA).

3. The computer-implemented method of claim 1, wherein the telemetry stream is configured to reduce one or more of a network packet delay or a packet drop rate.

4. The computer-implemented method of claim 1, wherein the receiving of the data comprises:
aggregating, for a given network device of the one or more network devices, the one or more network packets associated with the given network device into an indication message;
detecting a triggering event associated with the given network device; and
responsive to the detecting of the triggering event, sending the indication message.

5. The computer-implemented method of claim 4, wherein the triggering event is a new state for the given network device or a control traffic for the given network device.

6. The computer-implemented method of claim 4, wherein the indication message is indicative of a session establishment or a device authentication.

7. The computer-implemented method of claim 1, wherein the receiving of the data comprises:
receiving one or more network packets associated with the given network device during a granularity period; and
storing the one or more network packets in a buffer associated with the given network device prior to the sending of the indication message.

8. The computer-implemented method of claim 1, wherein the generating of the telemetry stream is performed by a security service component, and wherein the security service component is compliant with one or more policies of the RAN.

9. The computer-implemented method of claim 1, wherein the telemetry stream is a network device-centric telemetry stream, and further comprising:
tracking a temporary identifier associated with a given network device of the one or more network devices, wherein the temporary identifier enables an identification of a unique session establishment between the given network device and the RAN.

10. The computer-implemented method of claim 1, wherein the telemetry stream is a network device-centric telemetry stream, and further comprising:
tracking a temporary identifier associated with a given network device of the one or more network devices, wherein the temporary identifier enables an identification of a unique device authentication between the given network device and the RAN.

11. The computer-implemented method of claim 1, wherein the telemetry stream is a network device-centric telemetry stream, and further comprising:
tracking a permanent identifier associated with a given network device of the one or more network devices, wherein the permanent identifier comprises one or more of an International Mobile Equipment Identity (IMEI), an International Mobile Subscriber Identity (IMSI), or a Subscription Concealed Identifier (SUCI).

12. The computer-implemented method of claim 1, wherein the telemetry stream is a RAN-centric telemetry stream, and further comprising:
tracking aggregated statistics of one or more states associated with the RAN.

13. The computer-implemented method of claim 12, wherein the one or more states comprises one or more of a number of connected network devices, a number of idle network devices, or a maximum capacity associated with the RAN.

14. The computer-implemented method of claim 1, wherein the providing of the indication of the potential anomalous activity is performed by an application layer of the software-defined radio access network.

15. The computer-implemented method of claim 14, wherein the application layer is configured based on a Production-Based Expert System Toolset (P-BEST) language.

16. The computer-implemented method of claim 1, wherein a central unit (CU) comprises a CU-control (CU-C) and a CU-user (CU-U), and wherein:
the receiving of the data comprises:
receiving session establishment data from the CU-C, and
receiving device performance data from the CU-U, and
the providing of the indication of the potential anomalous activity is based on a correlation of the session establishment data and the device performance data.

17. The computer-implemented method of claim 1, wherein the SD-RAN is an open radio access network (O-RAN).

18. The computer-implemented method of claim 17, wherein the O-RAN comprises at least one logical node, and the receiving of the data comprises:
collecting, by a software agent deployed on the at least one logical node, respective RAN-related telemetry or network device-related telemetry.

19. The computer-implemented method of claim 18, wherein the at least one logical node comprises a Radio Unit (RU), a Distributed Unit (DU), or a Central Unit (CU).

20. The computer-implemented method of claim 1, wherein the SD-RAN is a higher generation cellular network.

21. A system for monitoring a software-defined radio access network (SD-RAN), comprising:
one or more network devices;
a base station configured to provide radio access to the one or more network devices;
one or more processors; and
data storage, wherein the data storage has stored thereon computer-executable instructions that, when executed by the one or more processors, cause a computing device to carry out operations comprising:
receiving, by the computing device, data indicative of communications between the base station and the one or more network devices;
generating, by the computing device and based on the data, a telemetry stream indicative of potential anomalous activity in the SD-RAN; and
providing, by the computing device and based on the telemetry stream, an indication of the potential anomalous activity.

22. The system of claim 21, wherein the SD-RAN is an open radio access network (O-RAN).

23. The system of claim 21, wherein the computing device comprises a first computing device in a network layer of the SD-RAN, and wherein the receiving of the data is performed by the first computing device, and wherein the first computing device is configured to operate in parallel with one or more logical nodes that manage protocols for the SD-RAN.

24. The system of claim 21, wherein the computing device comprises a second computing device in a control layer of the SD-RAN, wherein the generating of the telemetry stream is performed by the second computing device, and wherein the second computing device is configured to run in a RAN intelligent controller (RIC).

25. The system of claim 21, wherein the computing device comprises a third computing device in an application layer of the SD-RAN, and wherein the providing of the indication is performed by the third computing device.

26. A computing device for monitoring a software-defined radio access network (SD-RAN), comprising:
one or more processors; and
data storage, wherein the data storage has stored thereon computer-executable instructions that, when executed by the one or more processors, cause the computing device to carry out operations comprising:
receiving, by the computing device, data indicative of communications between a base station configured to provide radio access and one or more network devices;
generating, by the computing device and based on the data, a telemetry stream indicative of potential anomalous activity in the SD-RAN; and
providing, by the computing device and based on the telemetry stream, an indication of the potential anomalous activity.
